(19) United States
(12) Patent Application Publication
(10) Pub. No.: US 2024/0272722 A1
(43) Pub. Date: Aug. 15, 2024

(54) DISPLAYING AND MANIPULATING USER INTERFACE ELEMENTS

(71) Applicant: Apple Inc., Cupertino, CA (US)

(72) Inventors: Nathan GITTER, Cupertino, CA (US); Alexis H. PALANGIE, Palo Alto, CA (US); Aaron M. BURNS, Sunnyvale, CA (US); Benjamin HYLAK, San Francisco, CA (US)

(21) Appl. No.: 18/587,815

(22) Filed: Feb. 26, 2024

Related U.S. Application Data
(63) Continuation of application No. PCT/US2022/075481, filed on Aug. 25, 2022.
(60) Provisional application No. 63/237,943, filed on Aug. 27, 2021.

(51) Int. Cl. G06F 3/01; G06F 3/04815; G06F 3/04842; G06F 3/04847

(52) U.S. Cl. CPC G06F 3/017; G06F 3/013; G06F 3/04815; G06F 3/04842; G06F 3/04847

(57) ABSTRACT

Displaying and manipulating user interface elements in a computer-generated environment is disclosed. In some embodiments, a user is able to use a pinch and hold gesture to seamlessly and efficiently display and isolate a slider and then manipulate that slider without having to modify the pinch and hold gesture. In some embodiments, gaze data can be used to coarsely identify a focus element, and hand movement can then be used for fine identification of the focus element.

### CROSS-REFERENCE TO RELATED APPLICATIONS

This application is a continuation of International Application No. PCT/US2022/075481, filed Aug. 25, 2022, which claims the benefit of U.S. Provisional Application No. 63/237,943, filed Aug. 27, 2021, the contents of which are herein incorporated by reference in their entireties for all purposes.

### FIELD OF DISCLOSURE

This relates generally to methods for displaying and manipulating user interface elements in a computer-generated environment.

### BACKGROUND OF THE DISCLOSURE

Computer-generated environments are environments where at least some objects displayed for a user's viewing are generated using a computer. Users may interact with a computer-generated environment by displaying and manipulating selectable user interface elements from a menu user interface.

### SUMMARY OF THE DISCLOSURE

Some embodiments described in this disclosure are directed to methods for displaying and manipulating user interface elements in a computer-generated environment. Some embodiments described in this disclosure are directed to one-handed selection and actuation of selectable user interface elements. These interactions provide a more efficient and intuitive user experience. The full descriptions of the embodiments are provided in the Drawings and the Detailed Description, and it is understood that this Summary does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an electronic device displaying an extended reality environment according to some embodiments of the disclosure.

FIG. 2 illustrates a block diagram of an exemplary architecture for a system or device in accordance with some embodiments of the disclosure.

FIG. 3A illustrates a plurality of selectable user interface elements displayed or presented above or about a surface according to some embodiments of the disclosure.

FIG. 3B illustrates a representation of a hand of a user selecting a user interface element according to some embodiments of the disclosure.

FIG. 3C illustrates a representation of a hand of a user selecting a user interface element using a pinch and release gesture in conjunction with a gaze location according to some embodiments of the disclosure.

FIG. 4A illustrates a representation of a hand of a user selecting a user interface element for performing an analog operation using a pinch and hold gesture in conjunction with a gaze location according to some embodiments of the disclosure.

FIG. 4B illustrates a representation of a user interface element after it has been selected using a pinch and hold gesture as described with respect to FIG. 4A according to some embodiments of the disclosure.

FIG. 4C illustrates the indirect manipulation of a slider of a user interface element using movement of a hand while in a pinch and hold gesture according to some embodiments of the disclosure.

FIG. 4D illustrates the releasing of the indirect manipulation of the slider of a user interface element according to some embodiments of the disclosure.

FIG. 5A illustrates a representation of a hand of a user selecting a user interface element according to some embodiments of the disclosure.

FIG. 5B illustrates the presentation of a user interface after a user interface element is selected according to some embodiments of the disclosure.

FIG. 5C illustrates a slider and affordances of the user interface associated with a user interface element according to some embodiments of the disclosure.

FIG. 5D illustrates a user activating an affordance of the user interface associated with a user interface element according to some embodiments of the disclosure.

FIG. 5E illustrates a representation of a hand of a user indirectly selecting an affordance using a pinch and release gesture in conjunction with a gaze location according to some embodiments of the disclosure.

FIG. 5F illustrates a user directly selecting and manipulating a slider of the user interface associated with a user interface element according to some embodiments of the disclosure.

FIG. 5G illustrates a representation of a hand of a user indirectly selecting a slider using a pinch and hold gesture in conjunction with a gaze location according to some embodiments of the disclosure.

FIG. 5H illustrates the indirect manipulation of a slider of a user interface element using movement of a hand while in a pinch and hold gesture according to some embodiments of the disclosure.

FIG. 6A illustrates a representation of a hand of a user selecting a user interface element associated with an application according to some embodiments of the disclosure.

FIG. 6B illustrates the presentation of an application user interface after a user interface element is selected according to some embodiments of the disclosure.

FIG. 6C illustrates the use of eye gaze data to present selectable representations of system controls or affordances in the user interface of a selected application according to some embodiments of the disclosure.

FIG. 6D illustrates a user activating an affordance of the user interface of a selected application according to some embodiments of the disclosure.

FIG. 7A illustrates the indirect selection of a user interface element using eye gaze data and a pinch and release gesture according to some embodiments of the disclosure.

FIG. 7B illustrates the identification of a user interface element as the focus element using eye gaze data and hand movement according to some embodiments of the disclosure.

FIG. 7C illustrates the selection of a user interface element according to some embodiments of the disclosure.

FIG. 8 is a flow diagram illustrating a method of displaying and manipulating user interface elements in a computer-generated environment according to some embodiments of the disclosure.

FIG. 9 is a flow diagram illustrating a method of displaying and manipulating user interface elements in a computer-generated environment according to some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments. Further, although the following description uses terms “first,” “second,” etc. to describe various elements, these elements should not be limited by the terms. These terms are only used to distinguish one element from another. For example, a respective selectable option (e.g., control element) could be referred to as a “first” or “second” selectable option, without implying that the respective selectable option has different characteristics based merely on the fact that the respective selectable option is referred to as a “first” or “second” selectable option. On the other hand, a selectable option referred to as a “first” selectable option and a selectable option referred to as a “second” selectable option are both selectable options, but are not the same selectable option, unless explicitly described as such.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Some embodiments described in this disclosure are directed to methods for displaying and manipulating user interface elements in a computer-generated environment. Some embodiments described in this disclosure are directed to one-handed selection and actuation of selectable user interface elements. These interactions provide a more efficient and intuitive user experience.

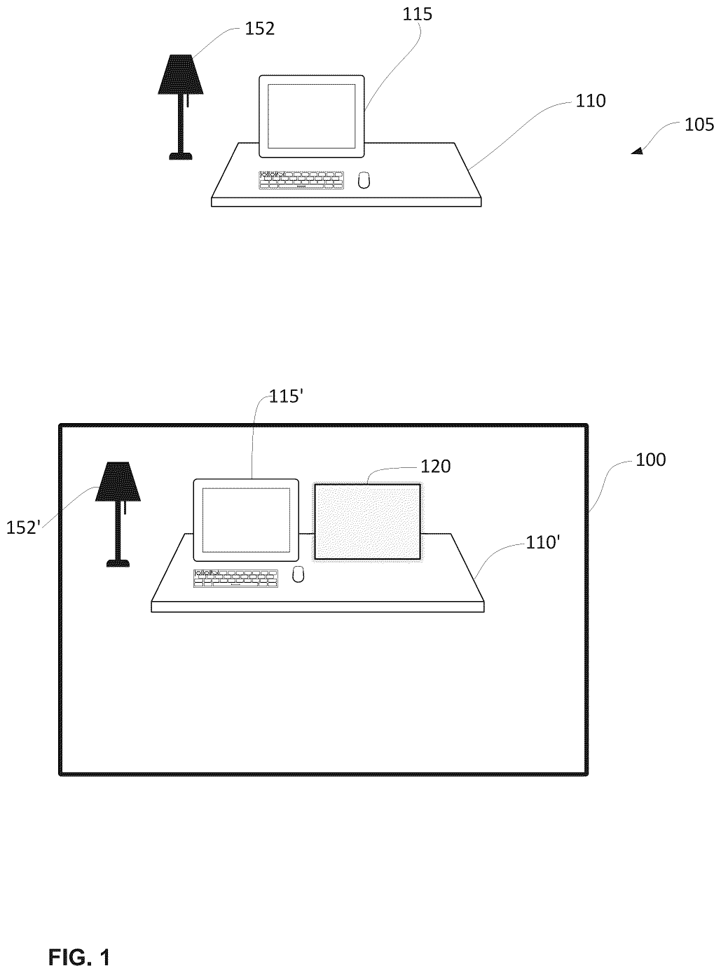

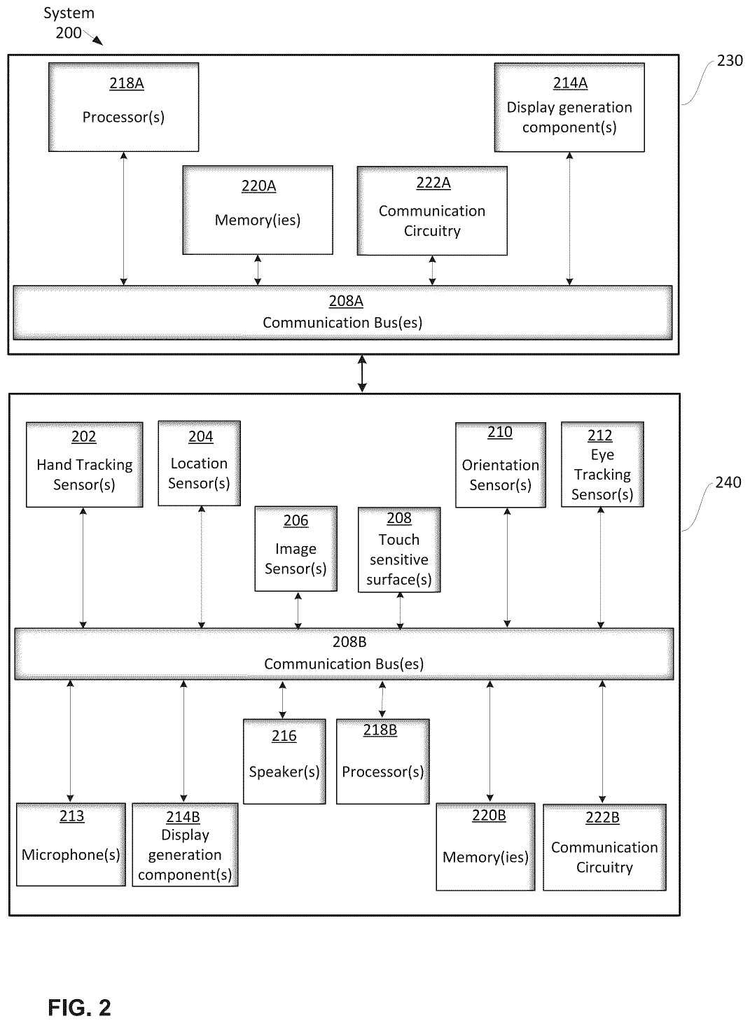

FIG. 1 illustrates an electronic device 100 displaying an extended reality (XR) environment (e.g., a computer-generated environment) according to embodiments of the disclosure. In some embodiments, electronic device 100 is a hand-held or mobile device, such as a tablet computer, laptop computer, smartphone, or head-mounted display. Additional examples of device 100 are described below with reference to the architecture block diagram of FIG. 2. As shown in FIG. 1, electronic device 100 and tabletop 110 are located in the physical environment 105. The physical environment may include physical features such as a physical surface (e.g., floor, walls) or a physical object (e.g., table, lamp, etc.). In some embodiments, electronic device 100 may be configured to capture areas of physical environment 105 including tabletop 110, lamp 152, desktop computer 115 and input devices 116 (illustrated in the field of view of electronic device 100). In some embodiments, in response to a trigger, the electronic device 100 may be configured to display a virtual object 120 in the computer-generated environment (e.g., represented by an application window illustrated in FIG. 1) that is not present in the physical environment 105, but is displayed in the computer-generated environment positioned on (e.g., anchored to) the top of a computer-generated representation 110′ of real-world table top 110. For example, virtual object 120 can be displayed on the surface of the tabletop 110′ in the computer-generated environment displayed via device 100 in response to detecting the planar surface of tabletop 110 in the physical environment 105.

It should be understood that virtual object 120 is a representative virtual object and one or more different virtual objects (e.g., of various dimensionality such as two-dimensional or three-dimensional virtual objects) can be included and rendered in a three-dimensional computer-generated environment. For example, the virtual object can represent an application or a user interface displayed in the computer-generated environment. In some embodiments, the virtual object 120 is optionally configured to be interactive and responsive to user input, such that a user may virtually touch, tap, move, rotate, or otherwise interact with, the virtual object. Additionally, it should be understood that, as used herein, the three-dimensional (3D) environment (or 3D virtual object) may be a representation of a 3D environment (or three-dimensional virtual object) projected or presented at an electronic device.

In the discussion that follows, an electronic device that is in communication with a display generation component and one or more input devices is described. It should be understood that the electronic device optionally is in communication with one or more other physical user-interface devices, such as touch-sensitive surface, a physical keyboard, a mouse, a joystick, a hand tracking device, an eye tracking device, a stylus, etc. Further, as described above, it should be understood that the described electronic device, display and/or touch-sensitive surface are optionally distributed amongst two or more devices. Therefore, as used herein, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

In some embodiments, the electronic device supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an exemplary architecture for a system or device 220 according to embodiments of the disclosure. In some embodiments, device 200 is a mobile device, such as a mobile phone (e.g., smart phone), a tablet computer, a laptop computer, a desktop computer, a head-mounted display, an auxiliary device in communication with another device, etc. In some embodiments, device 200 includes various sensors (e.g., one or more hand tracking sensor(s), one or more location sensor(s), one or more image sensor(s), one or more touch-sensitive surface(s), one or more motion and/or orientation sensor(s), one or more eye tracking sensor(s), one or more microphone(s) or other audio sensors, etc.), one or more display generation component(s), one or more speaker(s), one or more processor(s), one or more memories, and/or communication circuitry. One or more communication buses are optionally used for communication between the above-mentioned components of device 200.

In some embodiments, as illustrated in FIG. 2, system/device 200 can be divided between multiple devices. For example, a first device 230 optionally includes processor(s) 218A, memory or memories 220A, communication circuitry 222A, and display generation component(s) 214A optionally communicating over communication bus(es) 208A. A second device 240 (e.g., corresponding to device 200) optionally includes various sensors (e.g., one or more hand tracking sensor(s) 202, one or more location sensor(s) 204, one or more image sensor(s) 206, one or more touch-sensitive surface(s) 209, one or more motion and/or orientation sensor(s) 210, one or more eye tracking sensor(s) 212, one or more microphone(s) 213 or other audio sensors, etc.), one or more display generation component(s) 214B, one or more speaker(s) 216, one or more processor(s) 218B, one or more memories 220B, and/or communication circuitry 222B. One or more communication buses 208B are optionally used for communication between the above-mentioned components of device 240. In some embodiments, first device 230 and second device 240 communicate via a wired or wireless connection (e.g., via communication circuitry 222A-222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B may include one or more general processors, one or more graphics processors, and/or one or more digital signal processors. In some embodiments, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some embodiments, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. For example, the non-transitory computer-readable storage medium can include, but is not limited to, magnetic, optical, and/or semiconductor storages. In some embodiments, such storage may include magnetic disks, optical discs based on CD, DVD, or Blu-ray technologies, as well as persistent solid-state memory such as flash, solid-state drives, and the like.

In some embodiments, display generation component(s) 214A, 214B include a single display (e.g., a liquid-crystal display (LCD), organic light-emitting diode (OLED), or other types of display). In some embodiments, display generation component(s) 214A, 214B includes multiple displays. In some embodiments, display generation component(s) 214A, 214B can include a display with touch capability (e.g., a touch screen), a projector, a holographic projector, a retinal projector, etc. In some embodiments, device 240 includes touch-sensitive surface(s) 209 for receiving user inputs, such as tap inputs and swipe inputs or other gestures. In some embodiments, display generation component(s) 214B and touch-sensitive surface(s) 209 form touch-sensitive display(s) (e.g., a touch screen integrated with device 240 or external to device 240 that is in communication with device 240).

Device 240 optionally includes image sensor(s) 206. In some embodiments, image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from device 240. In some embodiments, information from one or more depth sensors can allow the device to identify and differentiate objects in the real-world environment from other objects in the real-world environment. In some embodiments, one or more depth sensors can allow the device to determine the texture and/or topography of objects in the real-world environment.

In some embodiments, device 240 uses CCD sensors, event cameras, and depth sensors in combination to detect the physical environment around device 240. In some embodiments, image sensor(s) 206 include a first image sensor and a second image sensor. The first image sensor and the second image sensor work in tandem and are optionally configured to capture different information of physical objects in the real-world environment. In some embodiments, the first image sensor is a visible light image sensor, and the second image sensor is a depth sensor. In some embodiments, device 240 uses image sensor(s) 206 to detect the position and orientation of device 240 and/or display generation component(s) 214 in the real-world environment. For example, device 240 uses image sensor(s) 206 to track the position and orientation of display generation component(s) 214B relative to one or more fixed objects in the real-world environment.

In some embodiments, device 240 includes microphone(s) 213 or other audio sensors. Device 240 uses microphone(s) 213 to detect sound from the user and/or the real-world environment of the user. In some embodiments, microphone(s) 213 includes an array of microphones (a plurality of microphones) that optionally operate in tandem, such as to identify ambient noise or to locate the source of sound in space of the real-world environment.

Device 240 includes hand tracking sensor(s) 202 and/or eye tracking sensor(s) 212, in some embodiments. Hand tracking sensor(s) 202 are configured to track the position/location of one or more portions of the user's hands, and/or motions of one or more portions of the user's hands with respect to the extended reality environment, relative to the display generation component(s) 214B, and/or relative to another defined coordinate system. In some embodiments, eye tracking senor(s) 212 are configured to track the position and movement of a user's gaze (eyes, face, or head, more generally) with respect to the real-world or extended reality environment and/or relative to the display generation component(s) 214B. In some embodiments, hand tracking sensor(s) 202 and/or eye tracking sensor(s) 212 are implemented together with the display generation component(s) 214B. In some embodiments, the hand tracking sensor(s) 202 and/or eye tracking sensor(s) 212 are implemented separate from the display generation component(s) 214B.

In some embodiments, the hand tracking sensor(s) 202 can use image sensor(s) 206 (e.g., one or more IR cameras, 3D cameras, depth cameras, etc.) that capture three-dimensional information from the real-world including one or more hands (e.g., of a human user). In some embodiments, the hands can be resolved with sufficient resolution to distinguish fingers and their respective positions. In some embodiments, one or more image sensor(s) 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., for detecting gestures, touch, tap, etc.) can be advantageous in that it does not require the user to touch, hold or wear any sort of beacon, sensor, or other marker.

In some embodiments, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some embodiments, both eyes are tracked separately by respective eye tracking cameras and illumination sources, and a focus/gaze can be determined from tracking both eyes. In some embodiments, one eye (e.g., a dominant eye) is tracked by a respective eye tracking camera/illumination source(s).

Device 240 includes location sensor(s) 204 for detecting a location of device 240 and/or display generation component(s) 214B. For example, location sensor(s) 204 can include a GPS receiver that receives data from one or more satellites and allows device 240 to determine the device's absolute position in the physical world.

Device 240 includes orientation sensor(s) 210 for detecting orientation and/or movement of device 240 and/or display generation component(s) 214B. For example, device 240 uses orientation sensor(s) 210 to track changes in the position and/or orientation of device 240 and/or display generation component(s) 214B, such as with respect to physical objects in the real-world environment. Orientation sensor(s) 210 optionally include one or more gyroscopes and/or one or more accelerometers.

It should be understood that system/device 200 is not limited to the components and configuration of FIG. 2, but can include fewer, alternative, or additional components in multiple configurations. In some embodiments, system 200 can be implemented in a single device. A person using system 200, is optionally referred to herein as a user of the device.

As described herein, a computer-generated environment including various graphics user interfaces (“GUIs”) may be displayed using an electronic device, such as electronic device 100 or device 200, including one or more display generation components. The computer-generated environment can include one or more GUIs associated with an application.

For example, a computer-generated environment can display a menu or selectable options to cause launching or display of user interfaces for applications in the computer-generated environment. Similarly, the computer-generated environment can display a menu or selectable options to perform operations with respect to applications that are running in the computer-generated environment.

Embodiments of electronic devices, user interfaces for such devices, and associated processes for using such devices are described. In some embodiments, the user may interact with the user interface or computer-generated environment (e.g., an XR environment) via eye focus (gaze) and/or eye movement and/or via position, orientation or movement of one or more fingers/hands (or a representation of one or more fingers/hands) in space relative to the user interface or computer-generated environment. In some embodiments, eye focus/movement and/or position/orientation/movement of fingers/hands can be captured by cameras and other sensors (e.g., motion sensors). In some embodiments audio/voice inputs can be used to interact with the user interface or computer-generated environment captured by one or more audio sensors (e.g., microphones). Further, as described above, it should be understood that the described electronic device, display and touch-sensitive surface and/or other input devices/sensors are optionally distributed amongst two or more devices.

The electronic device typically supports a variety of applications that may be displayed in the computer-generated environment, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a content application (e.g., a photo/video management application), a digital camera application, a digital video camera application, a web browsing application, a digital music player application, a television channel browsing application, and/or a digital video player application.

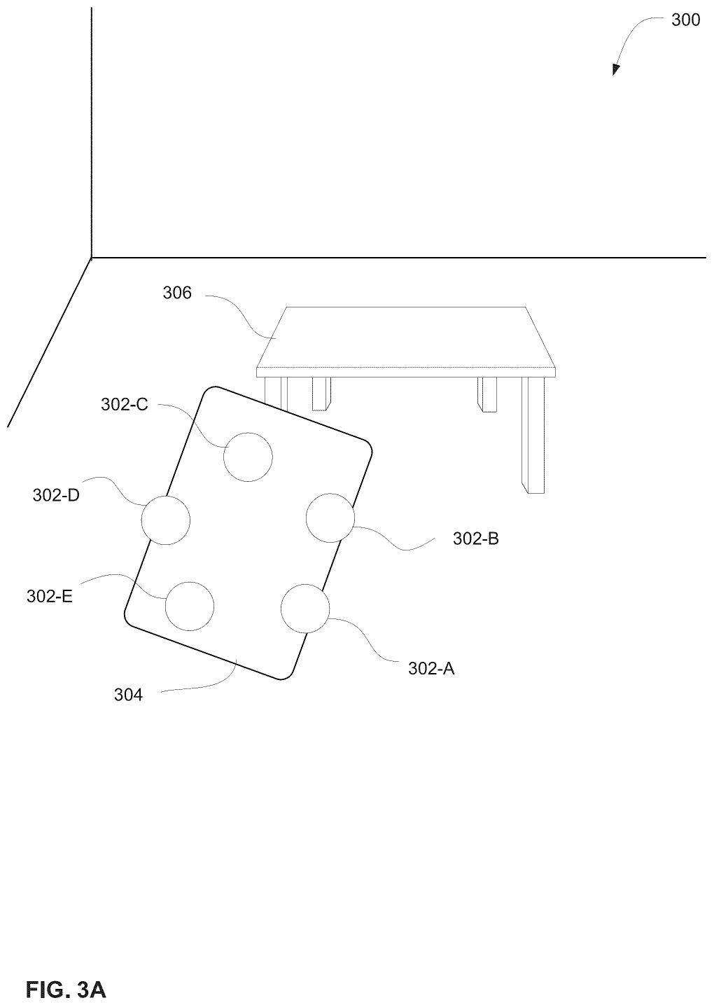

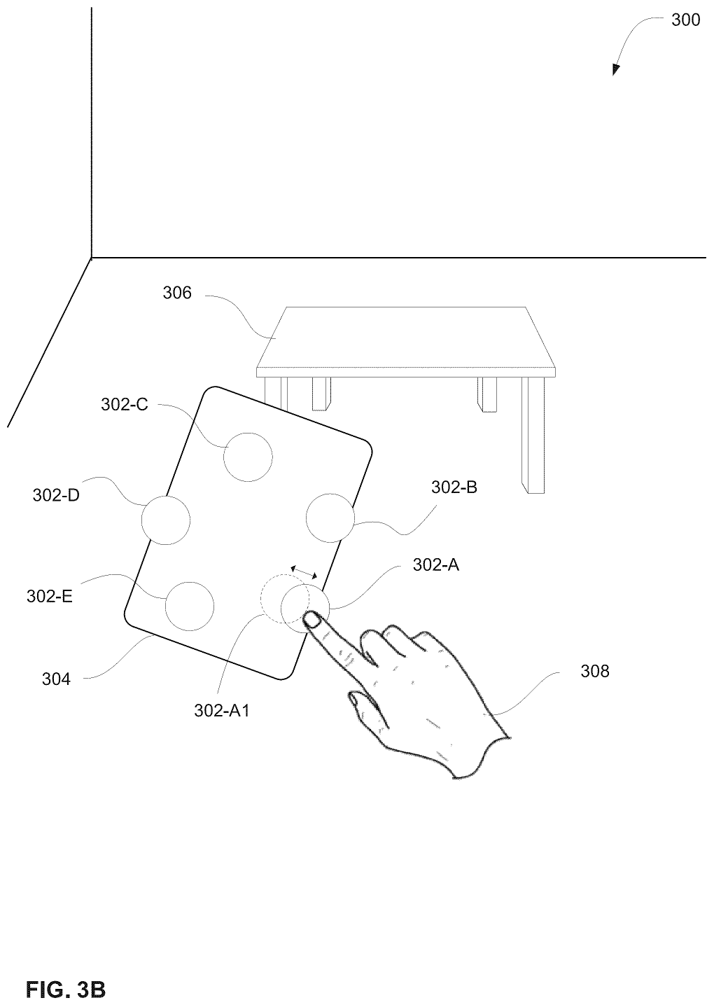

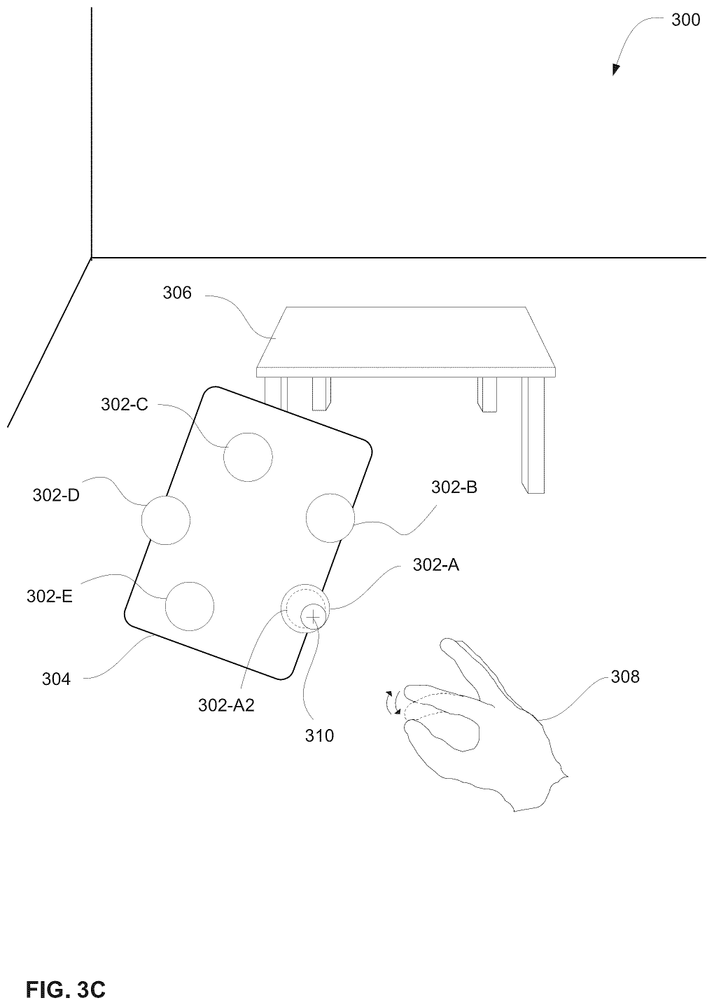

FIG. 3A illustrates a plurality of selectable user interface elements 302 displayed or presented above or about surface 304 according to some embodiments of the disclosure. In FIG. 3A, an electronic device (similar to electronic device 100 or 200 described above) is displaying computer-generated environment 300. As described above, computer-generated environment 300 can include representations of objects that are in the physical world around the electronic device (e.g., that are captured by one or more cameras of the electronic device or are permitted to be viewable to user via a transparent or translucent display). In the embodiment of FIG. 3A, table 306 is shown in computer-generated environment 300 as a representative example of one or more objects that may be present in the computer-generated environment. In FIG. 3A, table 306 is a representation of a table that is in the physical environment around the electronic device and has been captured by one or more capture devices of the electronic device. In some examples, computer-generated environment 300 can additionally or alternatively display one or more virtual objects (e.g., objects that are generated and displayed by the electronic device in computer-generated environment 300, but do not exist in the physical environment (e.g., real world environment) around the electronic device).

In the embodiment of FIG. 3A, computer-generated environment 300 also includes surface 304. Although surface 304 is illustrated as a rectangle in FIG. 3A, the rectangle is merely a symbolic representation of an object that can provide a surface. In one example, surface 304 is a representation of the back of a hand (or alternatively, the front of the hand) of a user of the electronic device that is present in the physical environment around the electronic device and has been captured by one or more capture devices of the electronic device. For example, the electronic device can capture an image of the hand of the user using one or more cameras of the electronic device and can display the hand in a three-dimensional computer-generated environment 300. In some examples, surface 304 can be a photorealistic depiction of the hand of the user or a caricature or outline of the hand of the user (e.g., a representation of a hand of the user). In examples where surface 304 is a representation of a hand, the electronic device can passively present the hand via a transparent or translucent display and can permit the hand to be viewable, for example, by not actively displaying a virtual object that obscures the view of the hand. In other examples, surface 304 can be a representation of other real objects (e.g., a clipboard, a paper, a board, a forearm or wrist, an electronic device, etc.) in the physical environment around the electronic device. As used herein, reference to a physical object such as hand can refer to either a representation of that physical object presented on a display, or the physical object itself as passively provided by a transparent or translucent display.

In accordance with a determination that one or more criteria are satisfied (e.g., when surface 304 is sufficiently facing the electronic device), the electronic device can display, via a display generation component, one or more user interface elements 302 in proximity to surface 304. In various examples, user interface elements 302 can be selectable user interface elements (affordances) of a control center, home screen, active application, etc. User interface elements 302 can include virtual buttons or icons that are selectable to adjust levels such as volume or brightness, toggle system controls such as Bluetooth, Wifi, airplane mode, or smart home functions, launch applications, and the like. In some examples, user interface elements 302 can be displayed as hovering over but anchored to surface 304 (e.g., above surface 304 by 1 cm, 1 inch, 2 inches, etc.), but in other examples the user interface elements can appear on the surface, below the surface, to one side the surface, etc., and can be represented as different shapes. Although five user interface elements 302 are shown in FIG. 3A for purposes of illustration, any number and arrangement of user interface elements may be presented.

FIG. 3B illustrates a representation of hand 308 of a user selecting user interface element 302-A according to some embodiments of the disclosure. In one embodiment, when a fingertip (or other digit) of hand 308 is determined to be within a threshold distance of user interface element 302-A (e.g., within 1 cm, 1 inch, etc. from the user interface element (e.g., from an edge or centroid of the user interface element)), the user interface element can be directly selected, and an operation associated with that user interface element can be initiated. While a physical object (e.g., the hand of the user) is in the physical environment, it should be appreciated that the electronic device may track the pose of the physical object in the physical environment and assign it (or a representation thereof) a corresponding pose in a common coordinate system with a virtual object (e.g., user interface elements 302) in computer-generated environment 300, such that a relative distance between it and the virtual object can be determined. In another embodiment, detection of the fingertip can be followed by the detection of the absence of the fingertip within a time limit (e.g., detection of a tap gesture) to select the user interface element. The user interface element can remain directly selected even after the selection input is no longer maintained (e.g., the fingertip (or other digit) of hand 308 is eventually removed, or after the tap gesture is completed). In some embodiments, when user interface element 302-A is directly selected, the user interface element may temporarily move to position 302-A1 before returning to its original position (as indicated by the arrow). This temporary movement or jitter of user interface element 302-A can provide a visual indication that the user interface element has been directly selected. In other embodiments, other visual indicators (e.g., different movements, or the changing of the size, color, brightness, etc. of user interface element 302-A), audio indicators (e.g., a chime or other sound) or tactile indicators (e.g., a vibration of the electronic device) can provide an indication that the user interface element has been directly selected. Although FIG. 3B illustrates a representation of the user's right hand 308 selecting user interface element 302-A, in other embodiments the user's left hand can also select user interface element 302-A, even when surface 304 is a representation of the user's left hand.

FIG. 3C illustrates a representation of hand 308 of a user selecting user interface element 302-A using a pinch and release gesture in conjunction with gaze location 310 according to some embodiments of the disclosure. In the embodiment of FIG. 3C, eye gaze data is collected and interpreted, and when gaze location 310 is determined to be within an “element lock distance threshold” of user interface element 302-A (e.g., within 1 cm, 1 inch, etc. from the user interface element (e.g., from an edge or centroid of the user interface element)), optionally for a certain period of time (e.g., an “element lock dwell time”), that user interface element is identified for potential selection (referred to herein as a focus element). These aforementioned criteria are referred to herein as gaze location criteria. In some embodiments, the focus element can be modified with a focus indicator to change its appearance (e.g., a change in color, shape, brightness, etc.) to assist a user in recognizing the focus element. When a pinch and release gesture (see arrows) is detected at hand 308 while gaze location 310 identifies user interface element 302-A as the focus element, that user interface element can be selected, and an operation associated with that user interface element can be initiated. Note that this selection process can be considered indirect because the gaze location identifies the focus element to be selected, and therefore the hand need not be in proximity to the identified focus element. In some examples, the hand can be non-overlapping and even remote from the focus element (e.g., 10 inches, 20 inches, etc. as estimated in computer-generated environment 300). In some embodiments, when user interface element 302-A is indirectly selected, the user interface element may temporarily shrink in size as shown at 302-A2 before returning to its original size. This temporary resizing of user interface element 302-A can provide a visual indication that the user interface element has been indirectly selected by the user. In other embodiments, other visual indicators (e.g., movement of user interface element 302-A, or the changing of the color, brightness, etc. of user interface element 302-A), audio indicators (e.g., a chime or other sound) or tactile indicators (e.g., a vibration of the electronic device) can provide an indication that the user interface element has been indirectly selected. Although FIG. 3C illustrates a pinch and release gesture to indirectly select user interface element 302-A, in other embodiments different hand gestures (e.g., a pointing index finger, an “OK” gesture, etc.) can be detected to perform the selection operation. Furthermore, although FIG. 3C illustrates a representation of the user's right hand 308 selecting user interface element 302-A using a pinch and release gesture, in other embodiments the user's left hand can also select user interface element 302-A using a pinch and release gesture, even when surface 304 is a representation of the user's left hand.

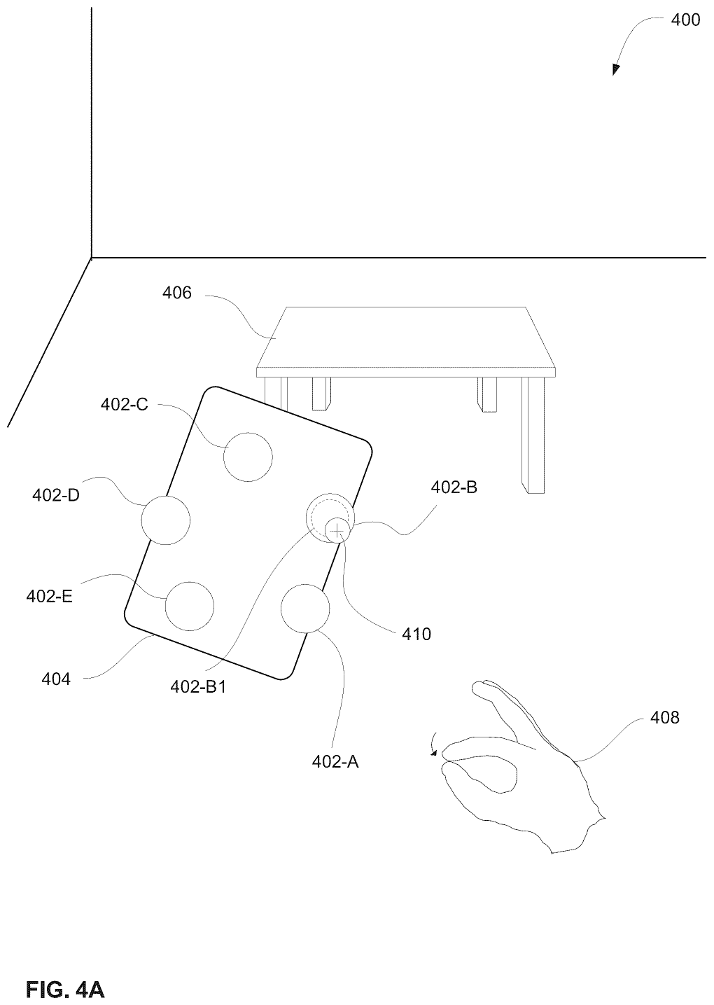

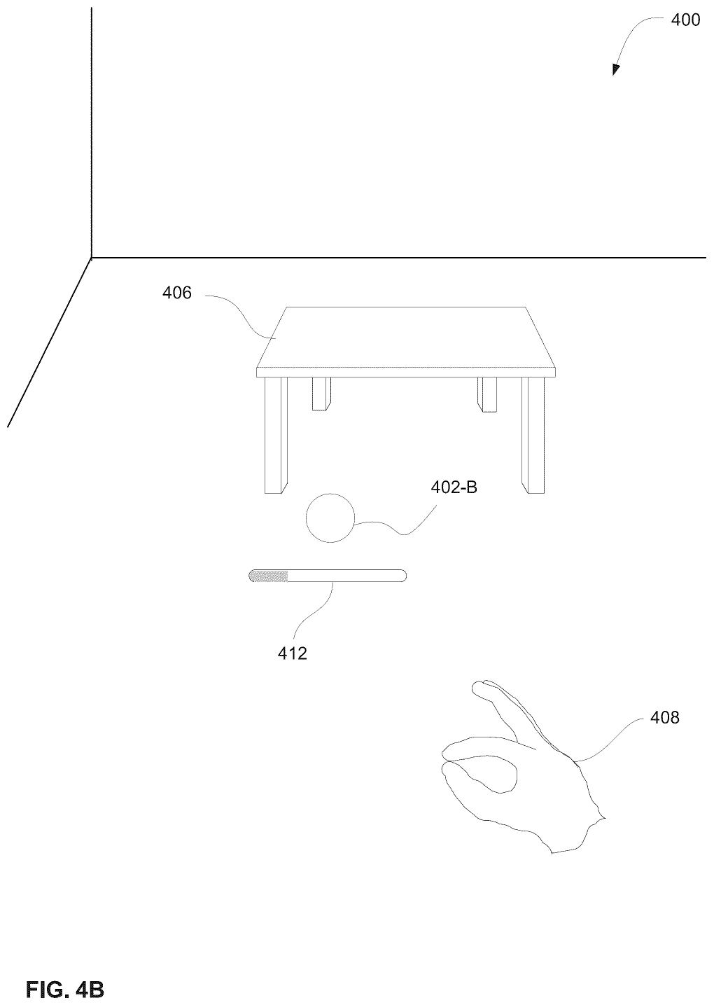

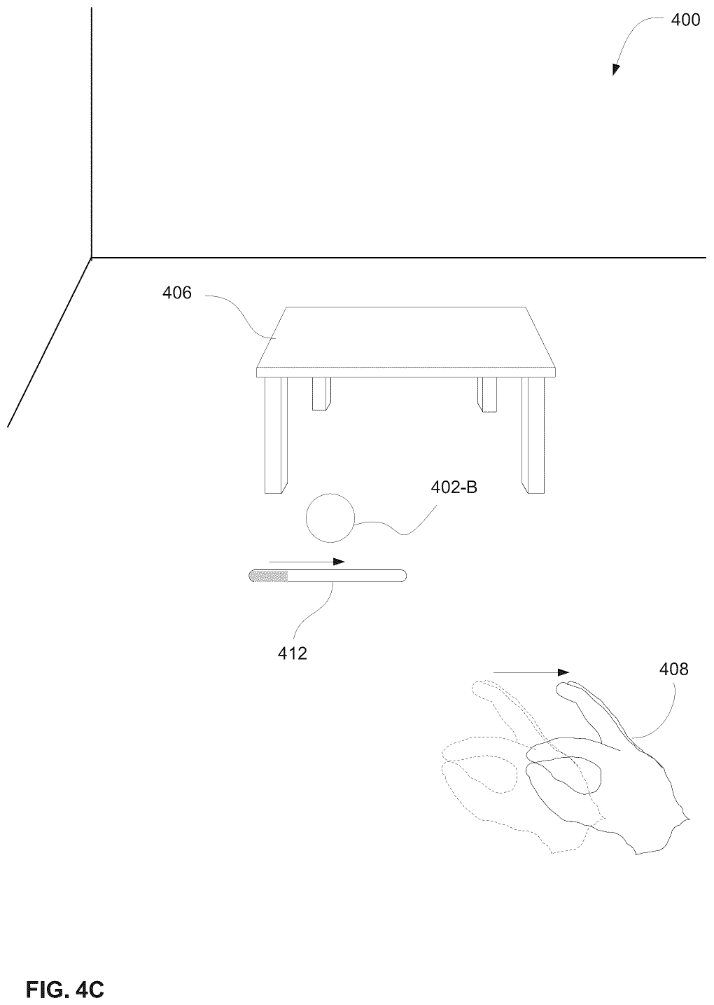

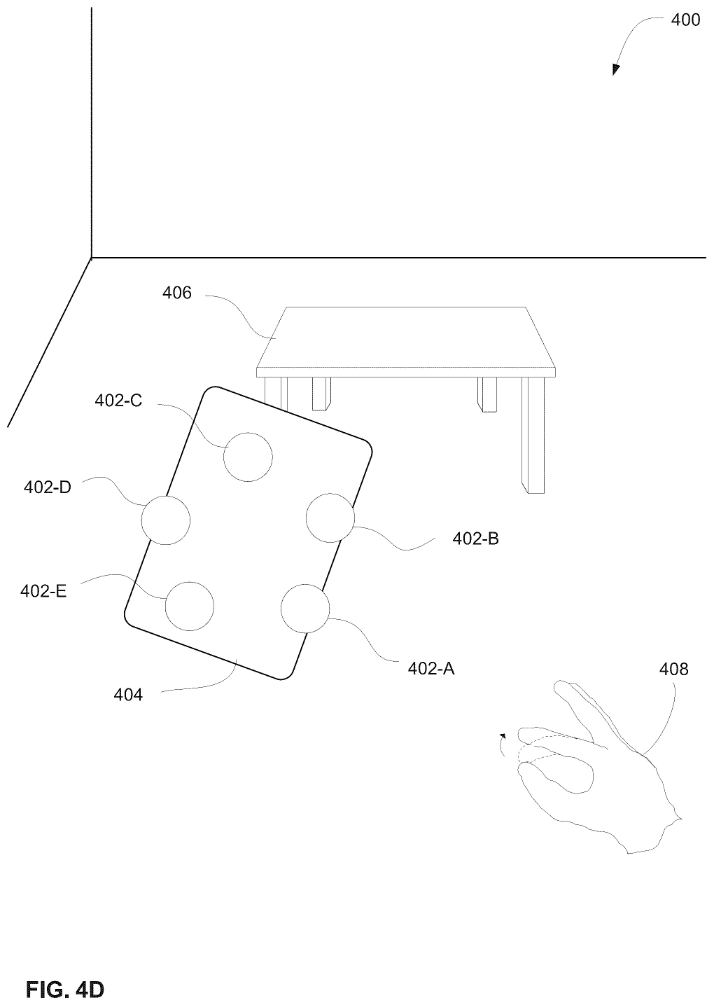

FIG. 4A illustrates a representation of hand 408 of a user selecting user interface element 402-B for performing an analog operation using a pinch and hold gesture in conjunction with gaze location 410 according to some embodiments of the disclosure. In one example for purposes of illustration, user interface element 402-B can be an audio control element, although other example analog operations are contemplated. In the embodiment of FIG. 4A, eye gaze data is collected and interpreted, and when gaze location 410 is determined to be within a threshold distance of user interface element 402-B (e.g., within 1 cm, 1 inch, etc. from the user interface element (e.g., from an edge or centroid of the user interface element)), optionally for a certain period of time (e.g., an “element lock dwell time”), that user interface element is identified for potential selection (referred to herein as a focus element). These aforementioned criteria may be referred to herein selection criteria. In some embodiments, the focus element can be modified with a focus indicator to change its appearance (e.g., a change in size, color, shape, brightness, etc.) to assist a user in recognizing the focus element. When a gesture such as a pinch and hold gesture (see arrow) is detected at an object such as hand 408 while gaze location 410 identifies user interface element 402-B as the focus element, that user interface element can be indirectly selected. Detection of this gesture may also be part of the selection criteria. In the example of FIG. 4A, when user interface element 402-B is indirectly selected, the user interface element temporarily shrinks in size as shown at 402-B1 before returning to its original size. This temporary resizing of user interface element 402-B can provide a visual indication that the user interface element has been indirectly selected by the user. In other embodiments, other visual indicators (e.g., movement of user interface element 402-B, or the changing of the color, brightness, etc. of user interface element 402-B), audio indicators (e.g., a chime or other sound) or tactile indicators (e.g., a vibration of the electronic device) can provide an indication that the user interface element has been indirectly selected. Although FIG. 4A illustrates a representation of the user's right hand 408 selecting user interface element 402-B using a pinch and hold gesture, in other embodiments the user's left hand can also select user interface element 402-B using a pinch and hold gesture, even when surface 304 is a representation of the user's left hand.

FIG. 4B illustrates a representation of user interface element 402-B after it has been selected using a pinch and hold gesture as described with respect to FIG. 4A according to some embodiments of the disclosure. As noted above, user interface element 402-B is associated with an analog operation, such as a setting or parameter (e.g., volume, brightness, etc.) that can be adjusted over a range of values. When a pinch and hold gesture is detected and user interface element 402-B has been selected as shown in FIG. 4A, a copy of user interface element 402-B (which may be a non-selectable visual reminder of which user interface element was selected) can be displayed at the location of original user interface element 402-B along with an affordance such as slider 412 while hand 408 continues to maintain a pinch and hold gesture (e.g., hold the pinch together) as shown in FIG. 4B. Continuing the example of FIG. 4A for purposes of illustration, slider 412 can be a volume control (or a control for another value) for audio control user interface element 402-B. In some embodiments, surface 404 and/or original user interface elements 402A-402-E can disappear from three-dimensional computer-generated environment 400 to isolate the copy of user interface element 402-B and slider 412.

FIG. 4C illustrates the indirect manipulation of slider 412 of user interface element 402-B using movement of hand 408 while in a pinch and hold gesture according to some embodiments of the disclosure. After slider 412 of user interface element 402-B has been displayed upon detection of a pinch and hold gesture as shown in FIG. 4B, movement of pinched hand 408 (e.g., with the pinch and hold gesture being maintained) that satisfies one or more movement criteria can cause an indicator in the slider to move or otherwise be modified in correspondence with the movement of the hand (e.g., by a proportional amount) as shown by the arrows in FIG. 4C. In some embodiments, the movement criteria can include, for example, a movement threshold (e.g., to ensure that small, unintentional hand movements do not cause a manipulation of the slider), or a directional movement criterion (e.g., to ensure that vertical movement of the hand does not cause the manipulation of a horizontal slider). Although FIG. 4C illustrates a representation of the user's right hand 408 manipulating slider 412 using a pinch and hold gesture, in other embodiments the user's left hand can also manipulate the slider using a pinch and hold gesture, even when surface 404 is a representation of the user's left hand.

As the progression from FIG. 4A to 4B to 4C demonstrates, the user is able to use a pinch and hold gesture to seamlessly and efficiently display and isolate slider 412 and then manipulate that slider without having to modify the pinch and hold gesture (other than moving hand 408). Note that although slider 412 is illustrated in FIGS. 4B and 4C as a progress bar, in other embodiments the slider can be displayed as a virtual slider with a virtually manipulable handle or lever, or it can be displayed in other forms that show a setting or parameter as a fraction over a range of possible values, such as a pie chart, donut chart, a simple percentage, etc.

FIG. 4D illustrates a releasing of the indirect manipulation of the slider of user interface element 402-A according to some embodiments of the disclosure. In FIG. 4D, when the pinch and hold gesture is finally released as shown by the arrow, surface 404 and/or original user interface elements 402A-402-E (see, e.g., FIG. 4A) can reappear in computer-generated environment 400, as long as the criteria for displaying the user interface elements on surface 404 is still satisfied. Additionally, in some embodiments, the value corresponding to the adjusted position of slider 412 when the pinch and hold gesture was released may be stored for the associated setting or parameter.

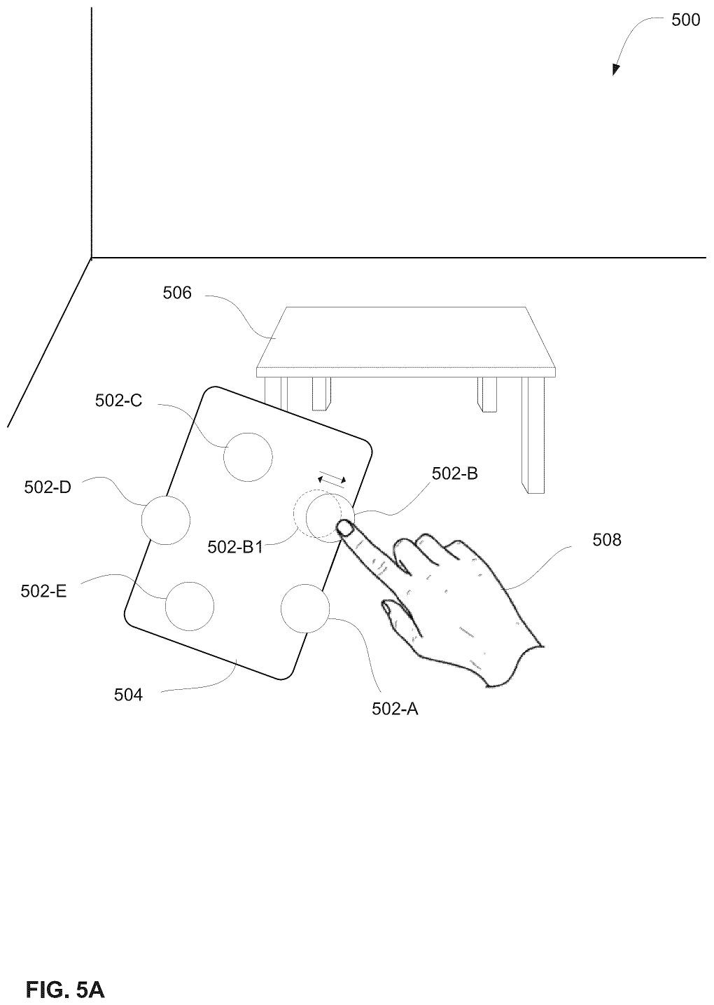

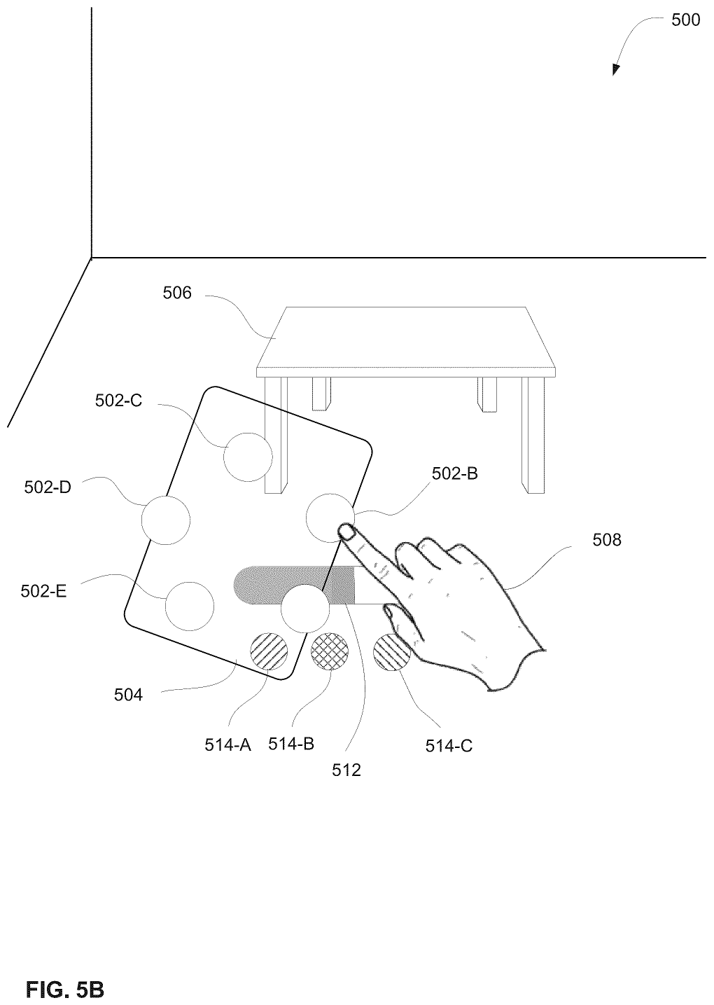

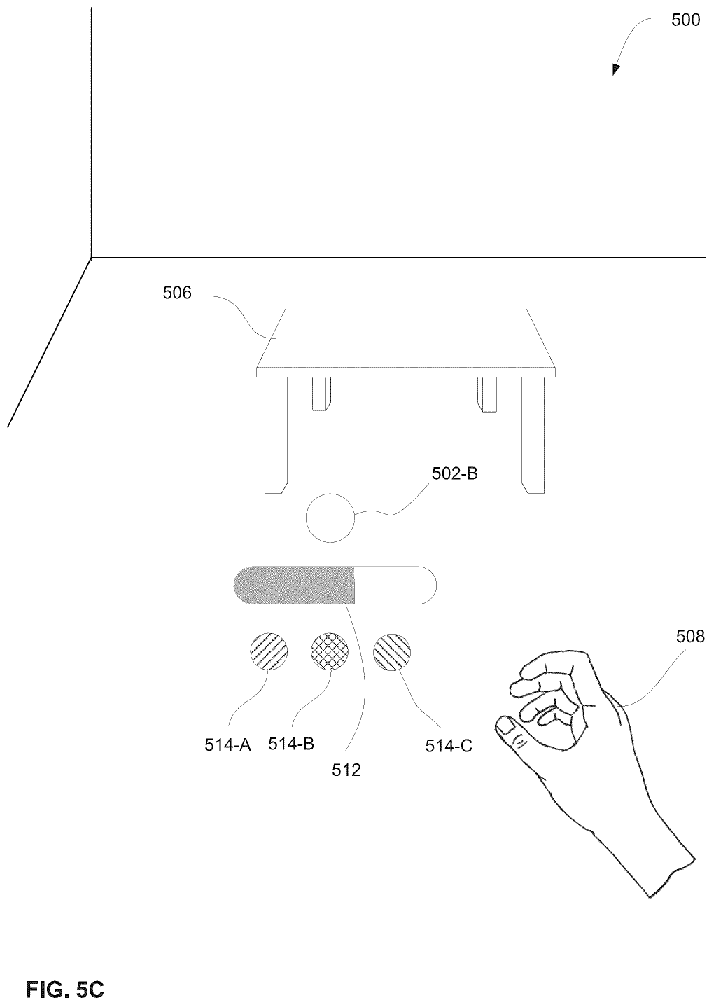

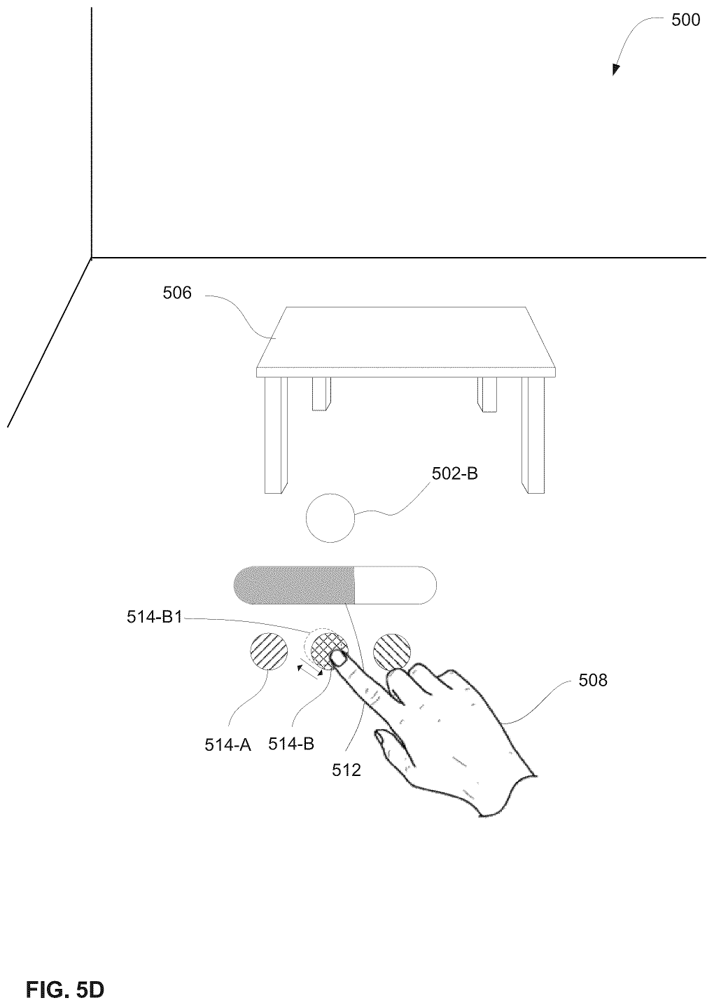

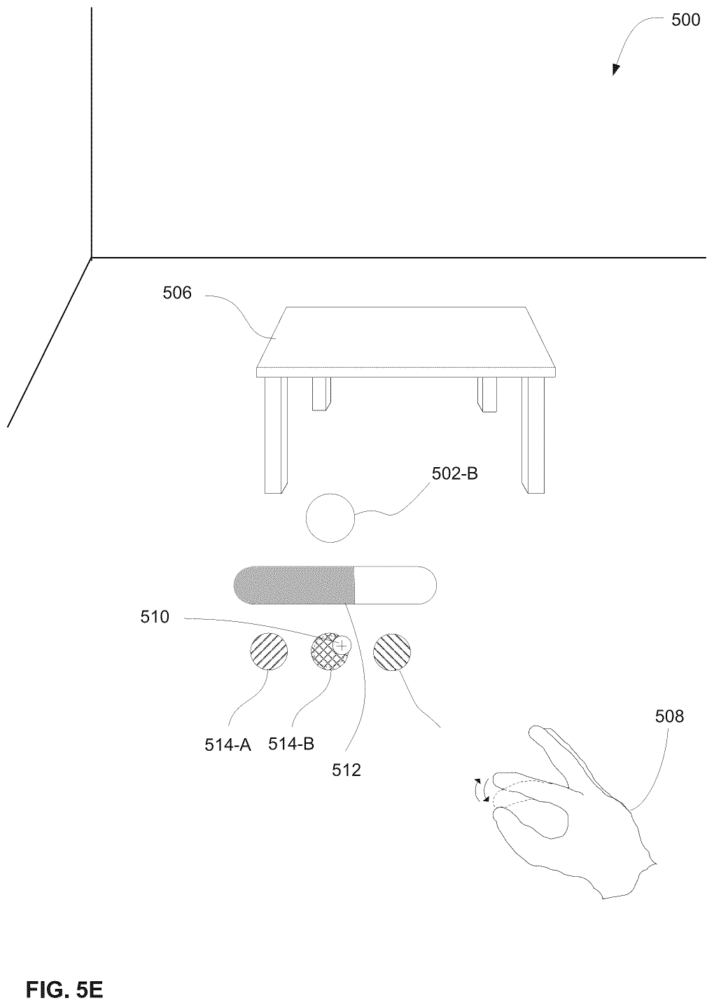

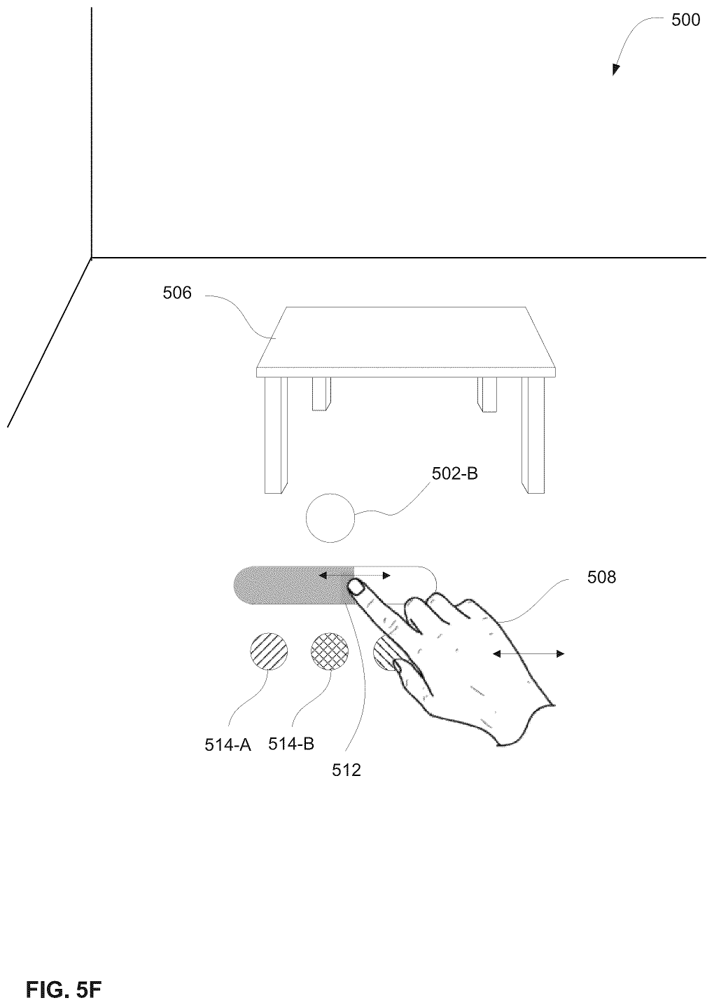

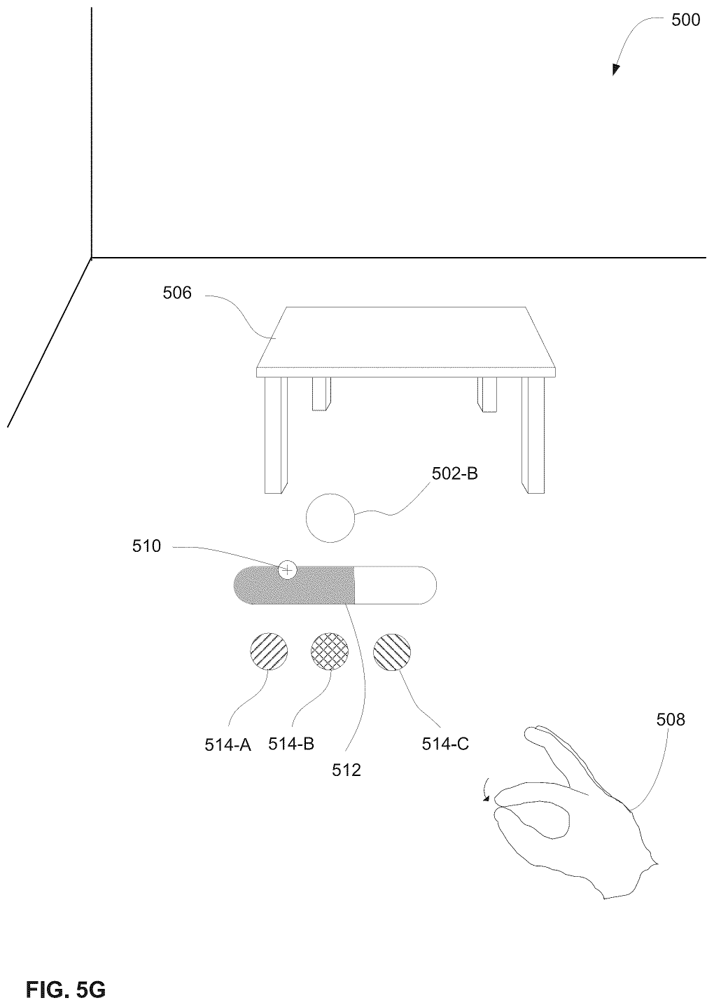

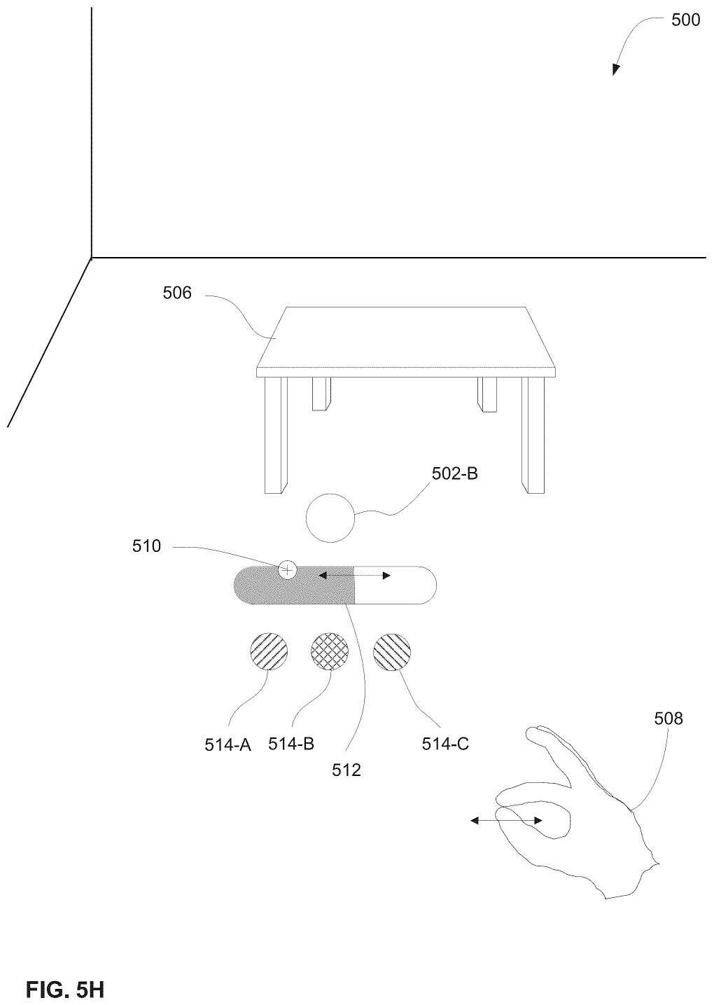

FIG. 5A illustrates a representation of hand 508 of a user selecting user interface element 502-B according to some embodiments of the disclosure. In one example for purposes of illustration, user interface element 502-B can be an audio control user interface element, although other example analog operations are contemplated. In FIG. 5A, when a fingertip (or other digit) of hand 508 is determined to be within a threshold distance of user interface element 502-B (e.g., within 1 cm, 1 inch, etc. from the user interface element (e.g., from an edge or centroid of the user interface element)), the user interface element can be directly selected, and an operation associated with that user interface element can be initiated. In another embodiment, detection of the fingertip can be followed by the detection of the absence of the fingertip within a time limit (e.g., detection of a tap gesture) to select the user interface element. The user interface element can remain directly selected even after the selection input is no longer maintained (e.g., the fingertip (or other digit) of hand 508 is eventually removed, or after the tap gesture is completed). In some embodiments, when user interface element 502-B is directly selected, the user interface element may temporarily move to position 502-B1 before returning to its original position, as indicated by the two arrows in FIG. 5A. This temporary movement or jitter of user interface element 502-B can provide a visual indication that the user interface element has been directly selected. In other embodiments, other visual indicators (e.g., different movements or the changing of the size, color, brightness, etc. of user interface element 502-B), audio indicators (e.g., a chime or other sound) or tactile indicators (e.g., a vibration of the electronic device) can provide an indication that the user interface element has been directly selected. Although FIG. 5A illustrates a finger touch (or tap) to directly select user interface element 502-B, in other embodiments other gestures (e.g., pinch and release, double tap, etc.) can be detected at the location of user interface element 502-B to directly select user interface element 502-B. Furthermore, although FIG. 5A illustrates a representation of the user's right hand 508 directly selecting user interface element 502-B, in other embodiments the user's left hand can also directly select user interface element 502-B, even when surface 504 is a representation of the user's left hand.

FIG. 5B illustrates the presentation of a user interface after user interface element 502-B is selected according to some embodiments of the disclosure. In the embodiment of FIG. 5B, after user interface element 502-B is selected as shown in FIG. 5A, a user interface associated with the user interface element including a copy of user interface element 502-B (which may be a non-selectable visual reminder of which user interface element was selected) can be displayed at the location of the original user interface element 502-B along with a visual indicator or affordance such as slider 512 and one or more other affordances 514. In some embodiments, this user interface can be unassociated with any surfaces in three-dimensional computer-generated environment 500 and instead can appear to “float” in the computer-generated environment.

FIG. 5C illustrates slider 512 and affordances 514 of the user interface associated with user interface element 502-B according to some embodiments of the disclosure. In the example of FIG. 5C, surface 504 and user interface elements 502-A through 502-E (see FIG. 5A) have been moved aside or otherwise removed from computer-generated environment 500, and hand 508 has also been moved aside, with a copy of user interface element 502-B, slider 512 and affordance 514 remaining in the environment. Continuing the example of FIG. 5A for purposes of illustration, the user interface of FIG. 5C can be a full audio controls user interface for audio control user interface element 502-B (in contrast to the simplified audio controls user interface of FIGS. 4B-4C), slider 512 can be a volume control, and affordances 514 can control other audio-related functions such as auxiliary speakers, surround sound, equalizer controls, etc.

FIG. 5D illustrates a user activating affordance 514-B of the user interface associated with user interface element 502-B according to some embodiments of the disclosure. In FIG. 5D, when a fingertip (or other digit) of hand 508 is determined to be within a threshold distance of affordance 514-B (e.g., within 1 cm, 1 inch, etc. from the user interface element (e.g., from an edge or centroid of the affordance)), the affordance can be directly selected, and an operation associated with that affordance can be initiated. In another embodiment, detection of the fingertip can be followed by the detection of the absence of the fingertip within a time limit (e.g., detection of a tap gesture) to select the affordance. These can be referred to as selection criteria. The user interface element can remain directly selected even after the selection input is no longer maintained (e.g., the fingertip (or other digit) of hand 508 is eventually removed, or after the tap gesture is completed). In some embodiments, when affordance 514-B is directly selected, the affordance may temporarily move to position 514-B1 before returning to its original position (as indicated by the two arrows). This temporary movement or jitter of affordance 514-B can provide a visual indication that the user interface element has been directly selected. In other embodiments, other visual indicators (e.g., different movements or the changing of the size, color, brightness, etc. of affordance 514-B), audio indicators (e.g., a chime or other sound) or tactile indicators (e.g., a vibration of the electronic device) can provide an indication that the affordance has been directly selected. Although FIG. 5D illustrates a representation of the user's right hand 508 selecting affordance 514-B, in other embodiments the user's left hand can also select affordance 514-B.

FIG. 5E illustrates a representation of hand 508 of a user indirectly selecting affordance 514-B using a pinch and release gesture in conjunction with gaze location 510 according to some embodiments of the disclosure. In the embodiment of FIG. 5E, eye gaze data is collected and interpreted, and when gaze location 510 is determined to be within a threshold distance of affordance 514-B (e.g., within 1 cm, 1 inch, etc. from the affordance (e.g., from an edge or centroid of the affordance)), optionally for a certain period of time (e.g., an “affordance lock dwell time”), that affordance is identified for potential selection (referred to herein as a focus affordance). These aforementioned criteria are referred to herein as selection criteria. In some embodiments, the focus affordance can be modified with a focus indicator to change its appearance (e.g., a change in color, shape, brightness, etc.) to assist a user in recognizing the focus affordance. When a pinch and release gesture (see arrows) is detected at hand 508 while gaze location 510 identifies affordance 514-B as the focus element, that affordance can be selected, and an operation associated with that affordance can be initiated. This gesture can also be considered part of the selection criteria.

Note that this selection process can be considered indirect because the gaze location identifies the affordance to be selected, and therefore the hand need not be in proximity to the identified affordance. In some embodiments, when affordance 514-B is indirectly selected, the user interface element may temporarily shrink in size as shown by the dashed circle within the affordance before returning to its original size. This temporary resizing of affordance 514-B can provide a visual indication that the affordance has been indirectly selected. In other embodiments, other visual indicators (e.g., movement of affordance 514-B, or the changing of the color, brightness, etc. of affordance 514-B), audio indicators (e.g., a chime or other sound) or tactile indicators (e.g., a vibration of the electronic device) can provide an indication that the affordance has been indirectly selected. Although FIG. 5E illustrates a pinch and release gesture to indirectly select affordance 514-B, in other embodiments different hand gestures (e.g., a pointing index finger, an “OK” gesture, etc.) can be detected to perform the selection operation. Furthermore, although FIG. 5E illustrates a representation of the user's right hand 508 indirectly selecting affordance 514-B using a pinch and release gesture, in other embodiments the user's left hand can also indirectly select affordance 514-B using a pinch and release gesture.

FIG. 5F illustrates a user directly selecting and manipulating slider 512 of the user interface associated with user interface element 502-B according to some embodiments of the disclosure. In FIG. 5F, when a fingertip (or other digit) of hand 508 is determined to be within a threshold distance of slider 512 (e.g., within 1 cm, 1 inch, etc. from the slider (e.g., from an edge, center of mass or centerline of the slider)), the slider can be directly selected. In some embodiments, visual indicators (e.g., temporary movement of slider 512, or the changing of the size, color, brightness, etc. of the slider), audio indicators (e.g., a chime or other sound) or tactile indicators (e.g., a vibration of the electronic device) can provide an indication that the slider has been directly selected. Thereafter, movement of hand 508 (e.g., with the pointing fingertip or other digit being maintained) that satisfies one or more movement criteria can cause slider to move in correspondence with the movement of the hand (e.g., by a proportional amount) as shown by the arrows in FIG. 5F, and an operation associated with that slider can be initiated. In some embodiments, the movement criteria can include, for example, a movement threshold (e.g., to ensure that small, unintentional hand movements do not cause a manipulation of the slider), or a directional movement criterion (e.g., to ensure that vertical movement of the hand does not cause the manipulation of a horizontal slider). Note that although slider 512 is illustrated in FIGS. 5B and 5F as a progress bar, in other embodiments the slider can be displayed as a virtual slider with a virtually manipulable handle or lever, or it can be displayed in other directly manipulable forms that show a setting or parameter as a fraction over a range of possible values, such as a pie chart, donut chart, a simple percentage, etc. Furthermore, although FIG. 5F illustrates a representation of the user's right hand 508 directly selecting and manipulating slider 512, in other embodiments the user's left hand can also directly select and manipulate the slider.

FIG. 5G illustrates a representation of hand 508 of a user indirectly selecting slider 512 using a pinch and hold gesture in conjunction with gaze location 510 according to some embodiments of the disclosure. In the embodiment of FIG. 5G, eye gaze data is collected and interpreted, and when gaze location 510 is determined to be within a threshold distance of slider 512 (e.g., within 1 cm, 1 inch, etc. from the slider (e.g., from an edge, center of mass or centerline of the slider)), optionally for a certain period of time (e.g., an “affordance lock dwell time”), that slider is identified for potential selection (referred to herein as a focus affordance). These aforementioned criteria are referred to herein as gaze location criteria. In some embodiments, the focus affordance can be modified with a focus indicator to change its appearance (e.g., a change in color, shape, brightness, etc.) to assist a user in recognizing the focus affordance. When a pinch and hold gesture (see arrow) is detected at hand 508 while gaze location 510 identifies slider 512 as the focus affordance, that slider can be indirectly selected. Although FIG. 5G illustrates a representation of the user's right hand 508 indirectly selecting slider 512 using a pinch and hold gesture, in other embodiments the user's left hand can also indirectly select slider 512 using a pinch and hold gesture.

FIG. 5H illustrates the indirect manipulation of slider 512 of user interface element 502-B using movement of hand 508 while in a pinch and hold gesture according to some embodiments of the disclosure. After slider 512 of user interface element 502-B has been displayed upon detection of a pinch and hold gesture as shown in FIG. 5G, movement of pinched hand 508 can cause slider to move by a proportional amount as shown by the arrows in FIG. 5H. As the progression from FIG. 5G to 5H demonstrates, the user is able to use a pinch and hold gesture to seamlessly and efficiently select and manipulate slider 512 without having to modify the pinch and hold gesture (other than moving hand 508). Note that although slider 512 is illustrated in FIGS. 5G and 5H as a progress bar, in other embodiments the slider can be displayed as a virtual slider with a virtually manipulable handle or lever, or it can be displayed in other forms that show a setting or parameter as a fraction over a range of possible values, such as a pie chart, donut chart, a simple percentage, etc.

As demonstrated above with respect to FIGS. 4A-4B and FIGS. 5A-5C, depending on how a particular user interface element is selected, different user interfaces can be presented. For example, if a pinch and hold gesture is detected at a particular user interface element, a simplified user interface similar to the one shown in FIGS. 4B-4C with a copy of the selected user interface element and a slider can be presented, and the user can immediately begin adjustment of the slider by moving the hand while holding the pinch and hold pose. However, if a pinch and release gesture is instead detected at that particular user interface element, a full user interface similar to the one shown in FIGS. 5B-5H, including a copy of the user interface element, a slider, and one or more affordances, can be presented. Separate interactions with the full user interface are then necessary to activate those controls.

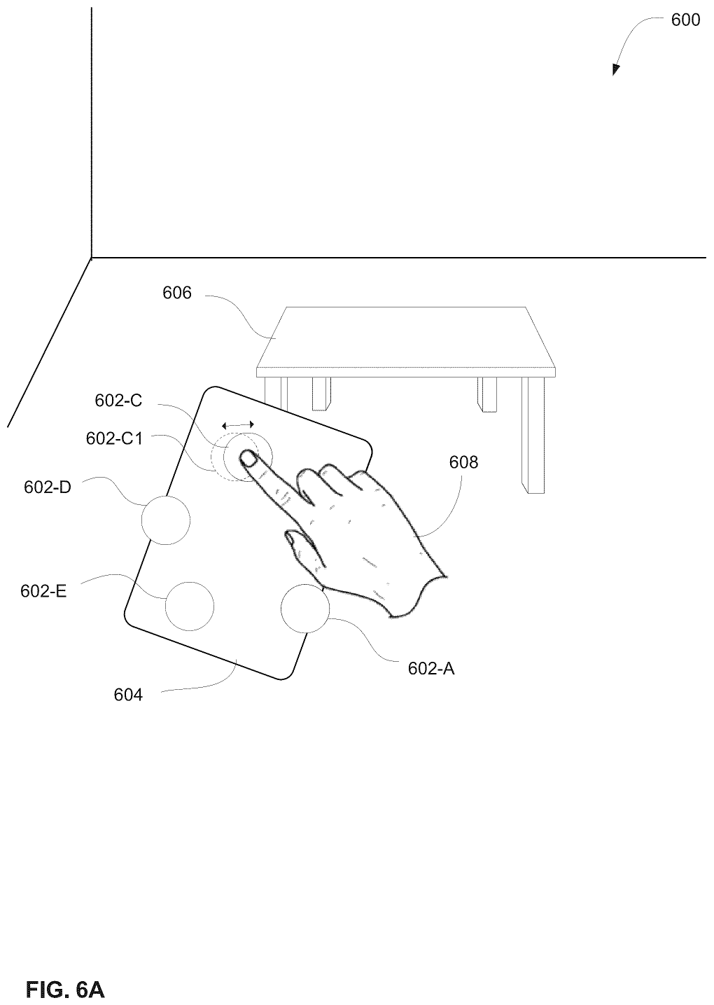

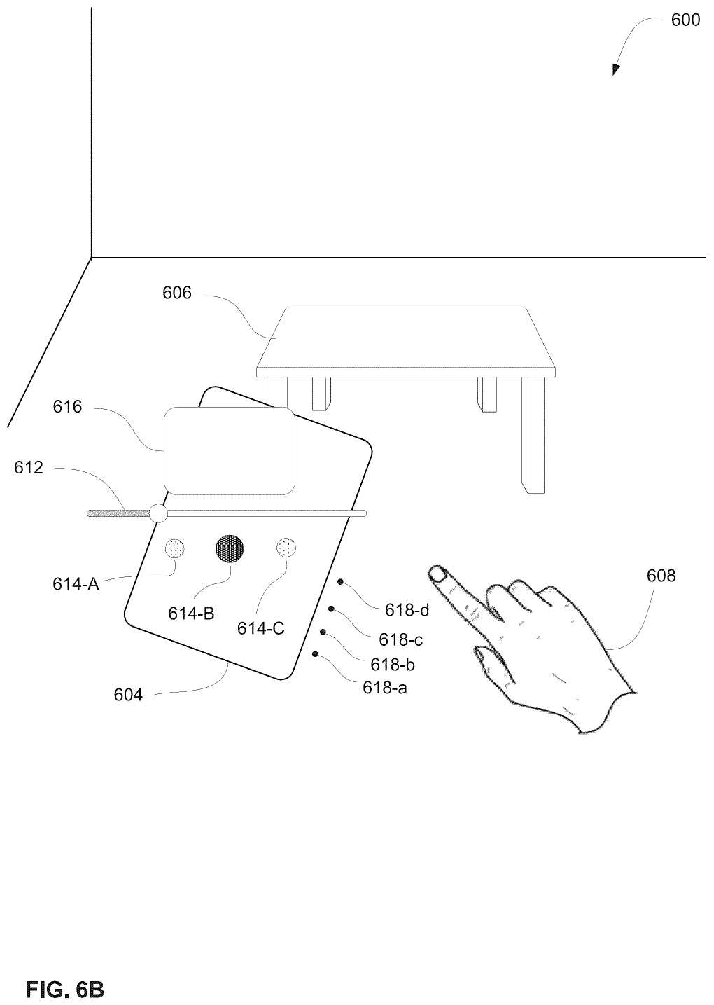

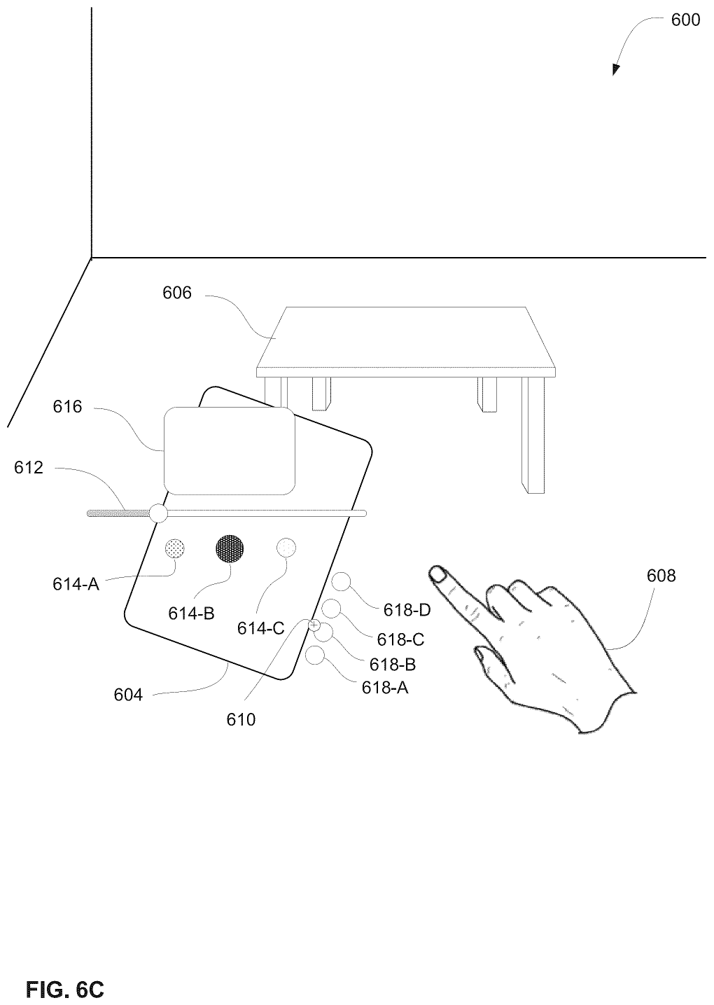

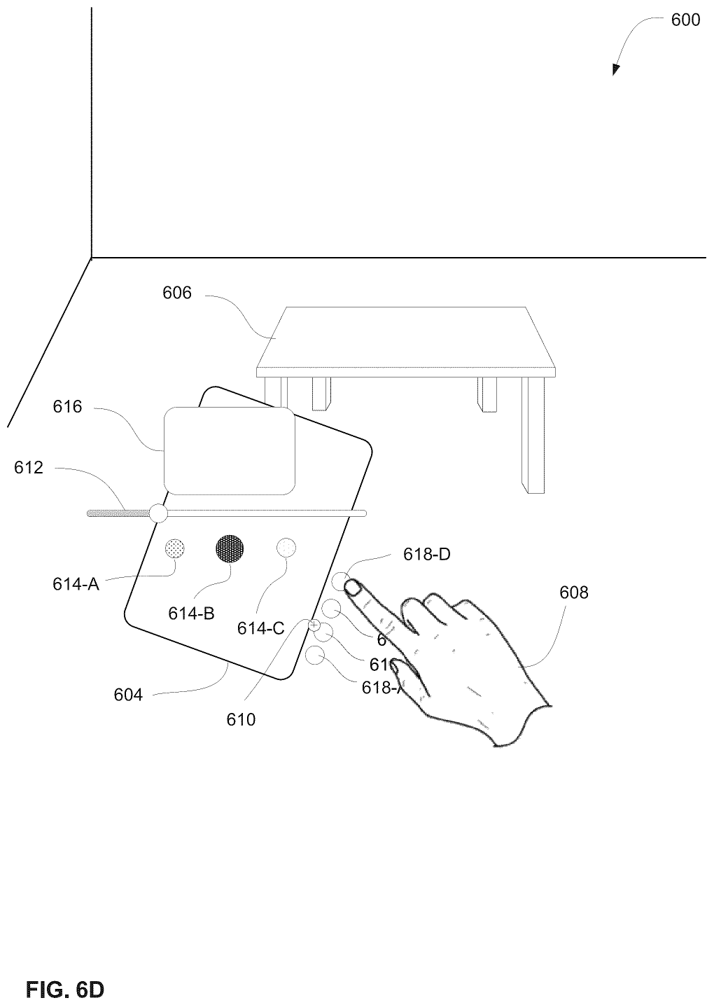

FIG. 6A illustrates a representation of hand 608 of a user selecting user interface element 602-C associated with an application according to some embodiments of the disclosure. In FIG. 6A, when a fingertip (or other digit) of hand 608 is determined to be within a threshold distance of user interface element 602-C (e.g., within 1 cm, 1 inch, etc. from the user interface element (e.g., from an edge or centroid of the user interface element)), the user interface element can be directly selected, and the presentation of a user interface for the application associated with the selected user interface element can be initiated. In another embodiment, detection of the fingertip can be followed by the detection of the absence of the fingertip within a time limit (e.g., detection of a tap gesture) to select the user interface element. The user interface element can remain directly selected even after the selection input is no longer maintained (e.g., the fingertip (or other digit) of hand 608 is eventually removed, or after the tap gesture is completed). In some embodiments, when user interface element 602-C is directly selected, the user interface element may temporarily move to position 602-C1 (as indicated by the arrow) before returning to its original position. This temporary movement or jitter of user interface element 602-C can provide a visual indication that the user interface element has been directly selected. In other embodiments, other visual indicators (e.g., different movements or the changing of the size, color, brightness, etc. of user interface element 602-C), audio indicators (e.g., a chime or other sound) or tactile indicators (e.g., a vibration of the electronic device) can provide an indication that the user interface element has been directly selected. Although FIG. 6A illustrates a representation of the user's right hand 608 selecting user interface element 602-C, in other embodiments the user's left hand can also select user interface element 602-C, even when surface 604 is a representation of the user's left hand.

FIG. 6B illustrates the presentation of an application user interface after user interface element 602-C is selected according to some embodiments of the disclosure. In the embodiment of FIG. 6B, after user interface element 602-C is selected (see FIG. 6A), all user interface elements 602 can disappear, and instead a user interface for the application associated with the selected user interface element including virtual screen 616, slider 612 and one or more affordances 614 can be presented. In some embodiments, this user interface can be associated with or anchored to surface 604 in three-dimensional computer-generated environment 600 and can appear to hover over the surface as the surface rotates in the computer-generated environment. In some embodiments, the user interface can remain gravity-aligned during the rotation of surface 604 (e.g., affordances in the user interface can rotate to maintain an upright appearance regardless of the rotation of the surface). In addition, in some embodiments the user interface can include dots 618-a to 618-d, which can be unselectable representations of other affordances (e.g., system controls not associated with the selected application, or other affordances associated with the selected application). Dots 618 can advantageously allow for a larger number of affordances to be present in the initial user interface, but in an unobtrusive location (e.g., outside of the boundary of surface 604) and with a reduced size and in an inactive state when not needed (e.g., when not being viewed (considered) by the user).

FIG. 6C illustrates the use of eye gaze data to present selectable representations of system controls or affordances in the user interface of a selected application according to some embodiments of the disclosure. In FIG. 6C, eye gaze data is collected and interpreted, and when gaze location 610 is determined to be within a threshold distance of any of unselectable dots 618-a to 618-d (see FIG. 6B) (e.g., within 1 cm, 1 inch, etc. from any of the dots (e.g., from an edge or centroid of the dot)), in some embodiments all of the dots can be expanded to selectable affordances 618-A to 618-D as shown in FIG. 6C. In other embodiments, only the dot closest to gaze location 610 is expanded to a selectable affordance. In some embodiments, dots 618 are expanded only after gaze location 610 is determined to be within the threshold distance of any of the dots for a certain period of time (e.g., a dwell time). The expansion of dots 618 to a larger size and to a selectable state only when identified by gaze location 610 can advantageously present those affordances to the user only when necessary (e.g., when being viewed (considered) by the user).

FIG. 6D illustrates a user activating affordance 618-D of the user interface of a selected application according to some embodiments of the disclosure. In FIG. 6D, when a fingertip (or other digit) of hand 608 is determined to be within a threshold distance of affordance 618-D (e.g., within 1 cm, 1 inch, etc. from the affordance (e.g., from an edge or centroid of the affordance)), the affordance can be directly selected, and an operation associated with that affordance can be initiated. In another embodiment, detection of the fingertip can be followed by the detection of the absence of the fingertip within a time limit (e.g., detection of a tap gesture) to select the user interface element. The affordance can remain directly selected even after the selection input is no longer maintained (e.g., the fingertip (or other digit) of hand 608 is eventually removed, or after the tap gesture is completed). Although FIG. 6D illustrates a representation of the user's right hand 608 selecting affordance 618-D, in other embodiments the user's left hand can also select the affordance. Note that slider 612 can also be manipulated by hand 608 in a manner similar to that discussed with respect to FIG. 5F, and affordances 614-A to 614-C can also be activated with a finger tap in a manner similar to that discussed with respect to FIG. 5D, although these manipulations and activations are not shown in FIG. 6D for purposes of simplifying the figure.

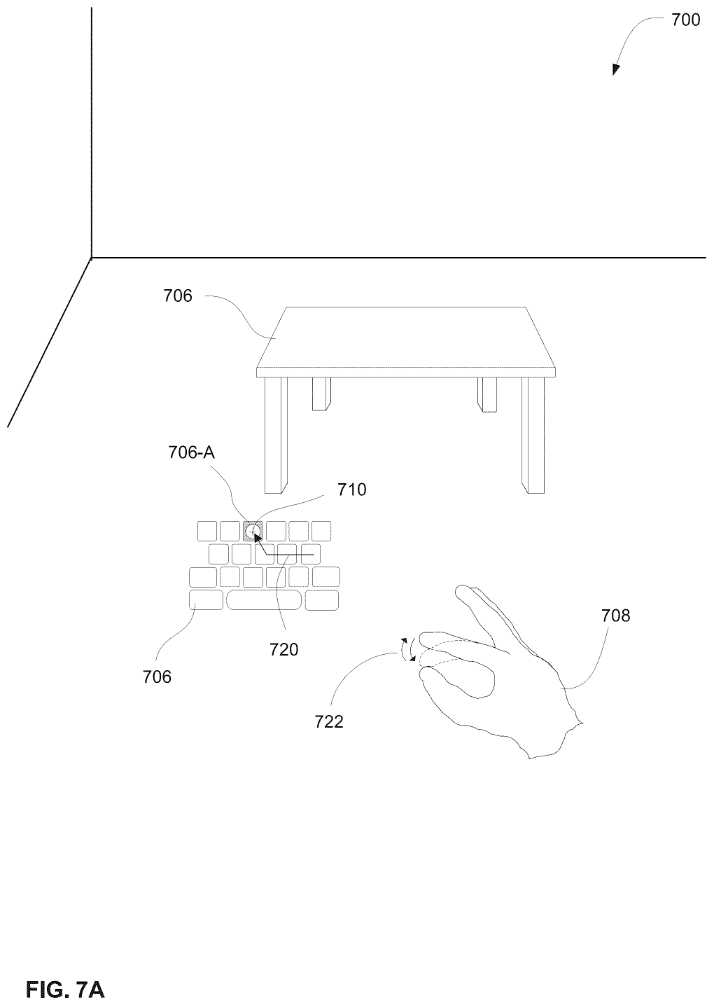

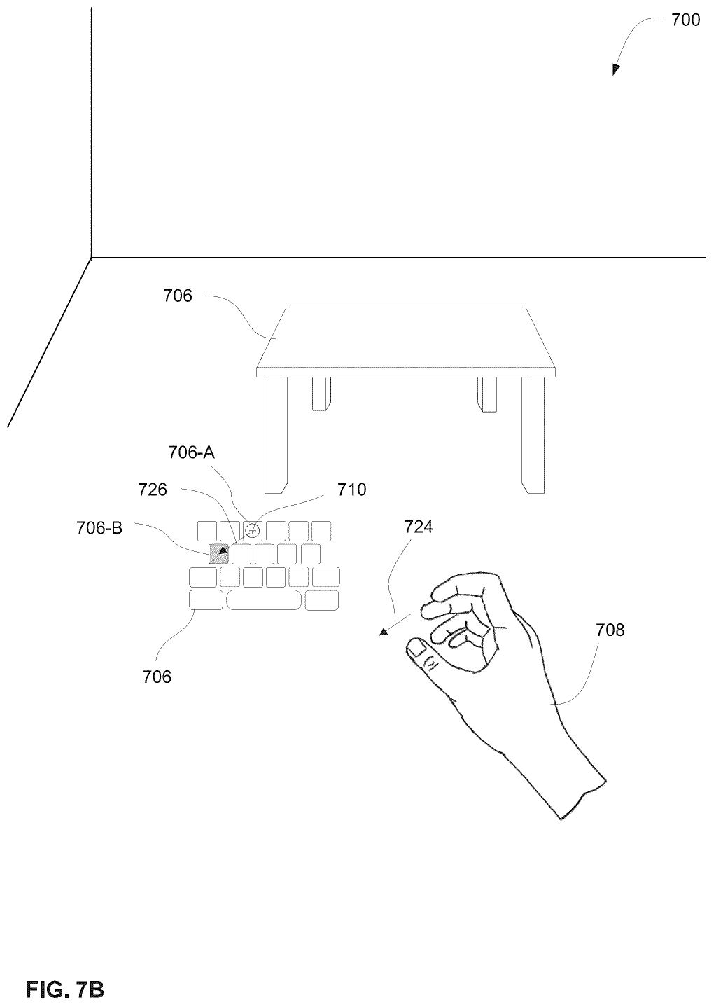

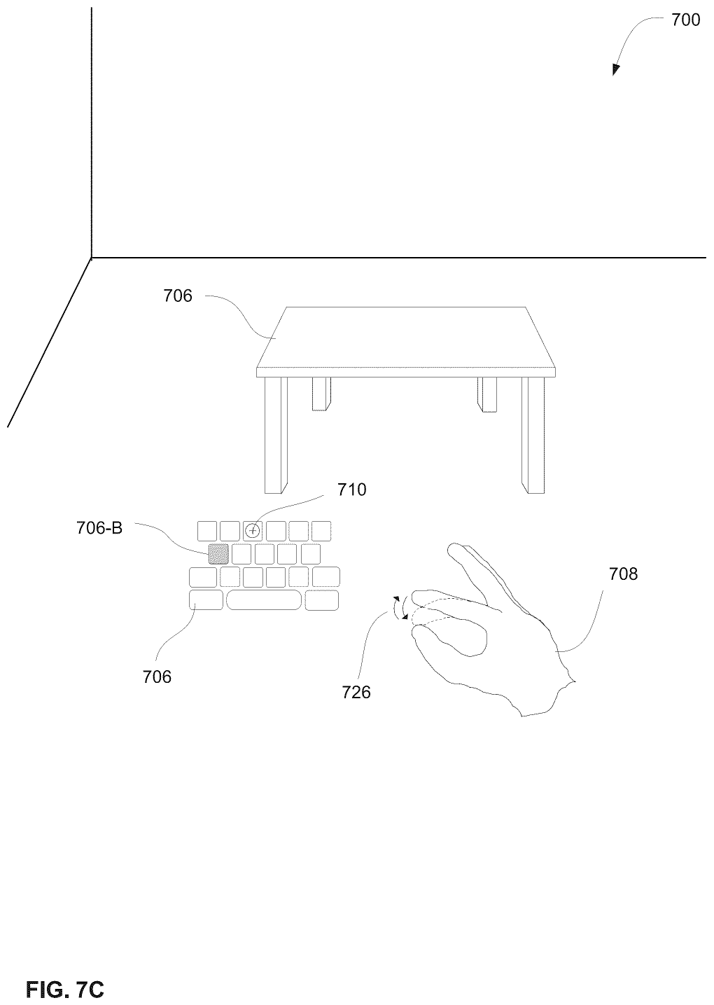

FIG. 7A illustrates the indirect selection of focus element 706-A using eye gaze data and a pinch and release gesture according to some embodiments of the disclosure. In FIG. 7A, the electronic device 700 can display, via a display generation component, one or more selectable user interface elements 706. Although FIG. 7A illustrates these user interface elements 706 as keys of a keyboard floating in three-dimensional computer-generated environment 700, this presentation of user interface elements is only one example, and in other examples these user interface elements can have other functions and can be located elsewhere in the environment, such as on table 706 or associated with a virtual object. In the embodiment of FIG. 7A, eye gaze data is collected and interpreted, and gaze location 710 can be tracked over time (see arrow 720). When gaze location 710 is determined to be within an “element lock distance threshold” of a user interface element (e.g., within 1 cm, 1 inch, etc. from the user interface element (e.g., from an edge or centroid of the user interface element)), optionally for a certain period of time (e.g., an “element lock dwell time”), that user interface element is identified for potential selection (referred to herein as the “focus element”). These aforementioned criteria are referred to herein as gaze location criteria. The user interface element identified for potential selection can be modified with a focus indicator to change its appearance (e.g., a change in color, shape, brightness, etc.) to assist a user in recognizing the focus element. In the embodiment of FIG. 7A, gaze location 710 has identified user interface element 706-A as the focus element, a pinch and release gesture (see arrows 722) is detected at hand 708 to indirectly select the focus element, and an operation associated with that focus element can be initiated. Note that this selection process can be considered indirect because the gaze location identifies the focus element to be selected, and therefore the hand need not be in proximity to the identified focus element. In some examples, hand 708 can be non-overlapping and in a different location from the focus element (e.g., 10 inches, 20 inches, etc. as estimated in computer-generated environment 300).

In some embodiments, when focus element 706-A is indirectly selected, the focus element may temporarily shrink before returning to its original size. This temporary resizing of focus element 706-A can provide a visual indication that the focus element has been indirectly selected by the user. In other embodiments, other visual indicators (e.g., movement of user interface element 706-A, or the changing of the color, brightness, etc. of focus element 706-A), audio indicators (e.g., a chime or other sound) or tactile indicators (e.g., a vibration of the electronic device) can provide an indication that the focus element has been indirectly selected. Although FIG. 7A illustrates a pinch and release gesture to indirectly select focus element 706-A, in other embodiments different hand gestures (e.g., a pointing index finger, an “OK” gesture, etc.) can be detected to perform the selection operation. Furthermore, although FIG. 7A illustrates a representation of the user's right hand 708 selecting focus element 706-A using a pinch and release gesture, in other embodiments the user's left hand can also select focus element 706-A using a pinch and release gesture.

FIG. 7B illustrates the identification of user interface element 706-B as the focus element using eye gaze data and hand movement according to some embodiments of the disclosure. In the example of FIG. 7B, gaze location 710 has initially identified user interface element 706-A as the focus element, and that focus element is initially visually identified with a focus indicator (although this initial focus indicator is not shown in FIG. 7B). If movement of an object such as hand movement 724 is detected, the focus element (and its focus indicator) can be changed in accordance with the hand movement as long as one or more focus adjustment criteria are satisfied. In the example of FIG. 7B, detected hand movement 724 causes the focus indicator (e.g., shading) to move from user interface element 706-A to 706-B, as indicated by arrow 726, despite gaze location 710 remaining at user interface element 706-A. If one or more focus criteria are satisfied, such as the distance between user interface elements 706-B and 706-A being less than a threshold amount, element 706-B can be identified as the focus element instead of element 706-A. In other words, the initial use of gaze location 710 can coarsely identify an initial focus element (e.g., element 706-A), and thereafter the subsequent use of hand movement 724 can make fine adjustments to change the focus element (e.g., to element 706-B).

In some embodiments, as long as hand movement 724 causes the focus indicator to deviate a relatively small amount (less than a focus adjustment threshold) from gaze location 710 (e.g., from 706-A to 706-B in the example of FIG. 7B), the focus element can be moved to the location of the focus indicator (e.g., element 706-B). In other words, hand movement 724 can be operable to cause relatively small changes to the focus element (and its focus indicator) only as long as the focus element remains within the focus adjustment threshold distance from the current gaze location 710. Small changes to the gaze location can be ignored in favor of the fine adjustments to the focus element generated by the hand movement. Disregarding small changes in gaze location 710 can advantageously relax the requirement that the user hold a fixed gaze during the fine adjustment of the focus element using hand 708. However, if a change in the focus indicator or a change in gaze location 710 is large enough such that the distance between the gaze location and the focus indicator does not satisfy one or more focus adjustment criteria, the focus element can be relocated to the user interface element closest to the gaze location. If the focus element is changed to the user interface element closest to the new gaze location, motion of hand 708 can thereafter cause the focus element to move again, from the user interface element closest to the new gaze location to a new user interface element as dictated by the hand motion.

FIG. 7C illustrates the selection of focus element 706-B according to some embodiments of the disclosure. In FIG. 7C, the hand movement of FIG. 7B has changed the focus element to user interface element 706-B, and thereafter when a pinch and release gesture is detected at hand 708 as indicated by arrows 726, focus element 706-B can be indirectly selected, and an operation associated with that focus element can be initiated. Although FIG. 7C illustrates a pinch and release gesture to indirectly select focus element 706-B, in other embodiments different hand gestures (e.g., a pointing index finger, an “OK” gesture, etc.) can be detected to perform the selection operation.

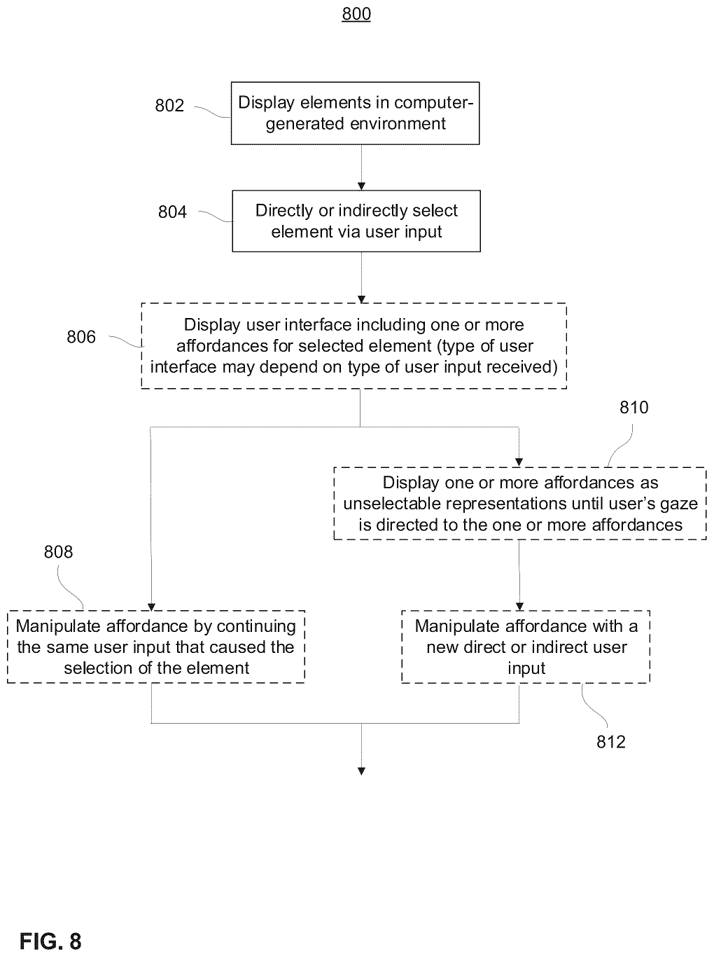

FIG. 8 is a flow diagram illustrating method 800 of displaying and manipulating user interface elements in a computer-generated environment according to some embodiments of the disclosure. Method 800 can be performed at an electronic device such as device 100, and device 200 when displaying and manipulating user interface elements described above with reference to FIGS. 3A-3C, 4A-4D, 5A-5H, 6A-6D, and 7A-7C. In some embodiments, some operations in method 800 are optional and/or may be combined (as indicated by dashed lines), and/or the order of some operations may be changed. As described below, method 800 provides methods of displaying and manipulating user interface elements in accordance with embodiments of the disclosure.

In FIG. 8, at 802, user interface elements can be displayed in the computer-generated environment (see, e.g., elements 302 in FIG. 3A, elements 402 in FIG. 4A, elements 502 in FIG. 5A, and elements 602 in FIG. 6A). At 804, a user interface element can be directly or indirectly selected via user input (see, e.g., selection actions in FIGS. 3B, 3C, 4A, 5A and 6A). In some embodiments, at 806, the selection of a user interface element via user input can cause a user interface for an operation associated with that user interface element to be presented (see, e.g., user interfaces shown in FIGS. 4B, 5B and 6B). In some embodiments, the type of user input detected at a particular user interface element can cause different user interfaces for that user interface element to be presented. In some embodiments, at 808, an affordance of the user interface can be manipulated by continuing the same user input that caused the selection of the user interface element (see, e.g., FIG. 4C). In some embodiments, at 810, one or more affordances of the user interface can be displayed as a smaller, unselectable graphics until a user's gaze is detected at the one or more affordances, at which time the graphics can expand to one or more selectable affordances (see, e.g., affordances 618 in FIGS. 6B and 6C). In some embodiments, at 812, an affordance of the user interface can be manipulated using a different direct or indirect user input from the user input that caused the selection of the user interface element (see, e.g., FIGS. 5C-5H, 6C and 6D).

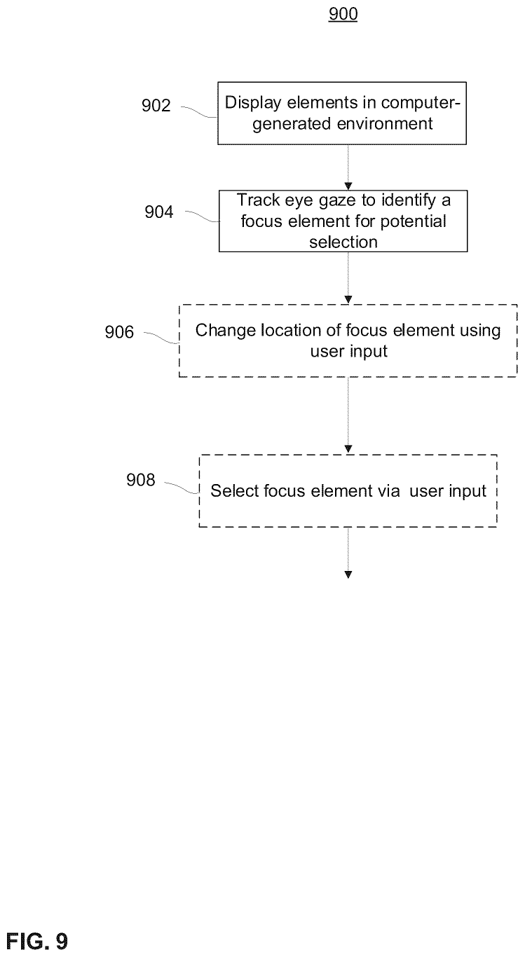

FIG. 9 is a flow diagram illustrating method 900 of displaying and manipulating user interface elements in a computer-generated environment according to some embodiments of the disclosure. Method 900 can be performed at an electronic device such as device 100, and device 200 when displaying and manipulating user interface elements described above with reference to FIGS. 3A-3C, 4A-4D, 5A-5H, 6A-6D, and 7A-7C. In some embodiments, some operations in method 900 are optional and/or may be combined (as indicated by dashed lines), and/or the order of some operations may be changed. As described below, method 900 provides methods of displaying and manipulating user interface elements in accordance with embodiments of the disclosure.

In FIG. 9, at 902, user interface elements can be displayed in the computer-generated environment (see, e.g., FIG. 7A). At 904, eye gaze data can be tracked and used to identify a focus element for potential selection (see, e.g., FIG. 7A). In some embodiments, at 906, the focus element can be selected via user input, such as a pinch and release gesture (see, e.g., FIG. 7A). In some embodiments, at 908, after eye gaze data has identified a focus element, user input such as hand movement can change the location of the focus element before the focus element is selected via further user input (see, e.g., FIG. 7B).

Therefore, according to the above, some examples of the disclosure are directed to a method comprising, at an electronic device in communication with a display, presenting, via the display, one or more user interface elements in a computer-generated environment, while presenting the one or more user interface elements, determining that one or more first selection criteria have been satisfied, including detection of a first gesture in the computer-generated environment, in accordance with the determination that the one or more first selection criteria have been satisfied, determining that a user interface element has been selected, in accordance with the determination that the user interface element has been selected and a determination that the first gesture is being maintained, detecting a movement gesture in the computer-generated environment, and in accordance with a determination that the movement gesture satisfies one or more movement criteria, adjusting a value associated with the selected user interface element. Alternatively or additionally to one or more of the examples disclosed above, in some examples in accordance with the determination that the user interface element has been selected and the determination that the first gesture is being maintained, presenting a first affordance associated with the selected user interface element in the computer-generated environment, the first affordance representative of the value being adjusted. Alternatively or additionally to one or more of the examples disclosed above, in some examples in accordance with the adjusting of the value associated with the selected user interface element, an appearance of the first affordance is modified. Alternatively or additionally to one or more of the examples disclosed above, in some examples the movement gesture is detected in the computer-generated environment at a location different from the first affordance. Alternatively or additionally to one or more of the examples disclosed above, in some examples the detection of the first gesture is performed in accordance with detecting a pinch and hold gesture performed by a hand in the computer-generated environment. Alternatively or additionally to one or more of the examples disclosed above, in some examples the method further comprises determining a gaze location, wherein the determination that the one or more first selection criteria have been satisfied includes determining a user interface element associated with the determined gaze location. Alternatively or additionally to one or more of the examples disclosed above, in some examples the first gesture is a pinch and hold gesture. Alternatively or additionally to one or more of the examples disclosed above, in some examples in accordance with the determination that the user interface element has been selected, causing other user interface elements to cease being presented in the computer-generated environment. Alternatively or additionally to one or more of the examples disclosed above, in some examples in accordance with a determination that the first gesture is no longer being maintained, causing, via the display, the one or more user interface elements to reappear in the computer-generated environment. Alternatively or additionally to one or more of the examples disclosed above, in some examples the method further comprises presenting, via the display, the one or more user interface elements anchored to a first hand of a user in the computer-generated environment, and wherein detecting the movement gesture is performed in accordance with detecting movements of the first hand of the user in the computer-generated environment. Alternatively or additionally to one or more of the examples disclosed above, in some examples in accordance with the determination that the user interface element has been selected and a determination that the first gesture is not maintained, presenting one or more second affordances associated with the selected user interface element. Alternatively or additionally to one or more of the examples disclosed above, in some examples the method further comprises, while presenting the one or more second affordances, determining that one or more second selection criteria have been satisfied, including detection of a second gesture in the computer-generated environment, and in accordance with a determination that the one or more second selection criteria have been satisfied, determining that a second affordance has been selected. Alternatively or additionally to one or more of the examples disclosed above, in some examples detecting the second gesture is performed in accordance with detecting a tap gesture performed by a hand in the computer-generated environment. Alternatively or additionally to one or more of the examples disclosed above, in some examples detecting the second gesture is performed in accordance with detecting a pinch and hold gesture performed by a hand in the computer-generated environment.

Some examples of the disclosure are directed to an electronic device, comprising one or more processors, memory, and one or more programs, wherein the one or more programs are stored in the memory and configured to be executed by the one or more processors, the one or more programs including instructions for presenting, via a display, one or more user interface elements in a computer-generated environment, while presenting the one or more user interface elements, determining that one or more first selection criteria have been satisfied, including detection of a first gesture in the computer-generated environment, in accordance with the determination that the one or more first selection criteria have been satisfied, determining that a user interface element has been selected, in accordance with the determination that the user interface element has been selected and a determination that the first gesture is being maintained, detecting a movement gesture in the computer-generated environment, and in accordance with a determination that the movement gesture satisfies one or more movement criteria, adjusting a value associated with the selected user interface element.

Some examples of the disclosure are directed to a non-transitory computer readable storage medium storing one or more programs, the one or more programs comprising instructions, which when executed by one or more processors of an electronic device, cause the electronic device to present, via a display, one or more user interface elements in a computer-generated environment, while presenting the one or more user interface elements, determine that one or more first selection criteria have been satisfied, including detection of a first gesture in the computer-generated environment, in accordance with the determination that the one or more first selection criteria have been satisfied, determine that a user interface element has been selected, in accordance with the determination that the user interface element has been selected and a determination that the first gesture is being maintained, detect a movement gesture in the computer-generated environment, and in accordance with a determination that the movement gesture satisfies one or more movement criteria, adjust a value associated with the selected user interface element.

Some examples of the disclosure are directed to an electronic device, comprising one or more processors, memory, means for presenting, via a display, one or more user interface elements in a computer-generated environment, means for, while presenting the one or more user interface elements, determining that one or more first selection criteria have been satisfied, including detection of a first gesture in the computer-generated environment, means for, in accordance with the determination that the one or more first selection criteria have been satisfied, determining that a user interface element has been selected, means for, in accordance with the determination that the user interface element has been selected and a determination that the first gesture is being maintained, detecting a movement gesture in the computer-generated environment, and means for, in accordance with a determination that the movement gesture satisfies one or more movement criteria, adjusting a value associated with the selected user interface element.

Some examples of the disclosure are directed to an information processing apparatus for use in an electronic device, the information processing apparatus comprising means for presenting, via a display, one or more user interface elements in a computer-generated environment, means for, while presenting the one or more user interface elements, determining that one or more first selection criteria have been satisfied, including detection of a first gesture in the computer-generated environment, means for, in accordance with the determination that the one or more first selection criteria have been satisfied, determining that a user interface element has been selected, means for, in accordance with the determination that the user interface element has been selected and a determination that the first gesture is being maintained, detecting a movement gesture in the computer-generated environment, and means for, in accordance with a determination that the movement gesture satisfies one or more movement criteria, adjusting a value associated with the selected user interface element.

Some examples of the disclosure are directed to an electronic device, comprising one or more processors, memory, and one or more programs, wherein the one or more programs are stored in the memory and configured to be executed by the one or more processors, the one or more programs including instructions for performing any of the methods disclosed above.

Some examples of the disclosure are directed to an electronic device, comprising one or more processors, memory, and one or more programs, wherein the one or more programs are stored in the memory and configured to be executed by the one or more processors, the one or more programs including instructions for performing any of the methods disclosed above.

Some examples of the disclosure are directed to a non-transitory computer readable storage medium storing one or more programs, the one or more programs comprising instructions, which when executed by one or more processors of an electronic device, cause the electronic device to perform any of the methods disclosed above.

Some examples of the disclosure are directed to an electronic device, comprising one or more processors, memory, and means for performing any of the methods disclosed above.

Some examples of the disclosure are directed to an information processing apparatus for use in an electronic device, the information processing apparatus comprising means for performing any of the methods disclosed above.

Some examples of the disclosure are directed to a method comprising, at an electronic device in communication with a display, presenting, via the display, a plurality of user interface elements in a computer-generated environment, while presenting the plurality of user interface elements, identifying a first user interface element from the plurality of user interface elements and a first location of the first user interface element as a focus element, wherein the identification of the first user interface element from the plurality of user interface elements and the first location is performed in accordance with determining a first gaze location from eye gaze data, while presenting the plurality of user interface elements including the identified focus element, detecting movement of a representation of an object in the computer-generated environment, in accordance with the detected movement of the representation of the object and the first location, identifying a second user interface element from the plurality of user interface elements and a second location of the second user interface element, in accordance with a determination that one or more focus adjustment criteria have been satisfied, identifying the second user interface element at the second location as the focus element, wherein the determination that the one or more focus adjustment criteria have been satisfied includes determining that a distance between the second location and the first location is within a focus adjustment threshold, and in accordance with a determination that the one or more focus adjustment criteria have not been satisfied, identifying a third user interface element from the plurality of user interface elements and a third location of the third user interface element as the focus element. Alternatively or additionally to one or more of the examples disclosed above, in some examples the identification of the third user interface element from the plurality of user interface elements is performed in accordance with determining a second gaze location from eye gaze data. Alternatively or additionally to one or more of the examples disclosed above, in some examples the method further comprises, in accordance with the identification of the third user interface element at the third location as the focus element, then in accordance with the detected movement of the representation of the object and the third location, identifying a fourth user interface element from the plurality of user interface elements and a fourth location of the fourth user interface element as the focus element. Alternatively or additionally to one or more of the examples disclosed above, in some examples the method further comprises detecting a selection gesture performed by the object in the computer-generated environment, and in accordance with the detection of the selection gesture, selecting the focus element. Alternatively or additionally to one or more of the examples disclosed above, in some examples the object is a hand in the computer-generated environment, and the selection gesture is a pinch and release gesture. Alternatively or additionally to one or more of the examples disclosed above, in some examples the movement of the hand is detected in the computer-generated environment at a fifth location different from the first and second locations.

Some examples of the disclosure are directed to an electronic device, comprising one or more processors, memory, and one or more programs, wherein the one or more programs are stored in the memory and configured to be executed by the one or more processors, the one or more programs including instructions for presenting, via a display, a plurality of user interface elements in a computer-generated environment, while presenting the plurality of user interface elements, identifying a first user interface element from the plurality of user interface elements and a first location of the first user interface element as a focus element, wherein the identification of the first user interface element from the plurality of user interface elements and the first location is performed in accordance with determining a first gaze location from eye gaze data, while presenting the plurality of user interface elements including the identified focus element, detecting movement of a representation of an object in the computer-generated environment, in accordance with the detected movement of the representation of the object and the first location, identifying a second user interface element from the plurality of user interface elements and a second location of the second user interface element, in accordance with a determination that one or more focus adjustment criteria have been satisfied, identifying the second user interface element at the second location as the focus element, wherein the determination that the one or more focus adjustment criteria have been satisfied includes determining that a distance between the second location and the first location is within a focus adjustment threshold, and in accordance with a determination that the one or more focus adjustment criteria have not been satisfied, identifying a third user interface element from the plurality of user interface elements and a third location of the third user interface element as the focus element.

Some examples of the disclosure are directed to a non-transitory computer readable storage medium storing one or more programs, the one or more programs comprising instructions, which when executed by one or more processors of an electronic device, cause the electronic device to present, via a display, a plurality of user interface elements in a computer-generated environment, while presenting the plurality of user interface elements, identify a first user interface element from the plurality of user interface elements and a first location of the first user interface element as a focus element, wherein the identification of the first user interface element from the plurality of user interface elements and the first location is performed in accordance with determining a first gaze location from eye gaze data, while presenting the plurality of user interface elements including the identified focus element, detect movement of a representation of an object in the computer-generated environment, in accordance with the detected movement of the representation of the object and the first location, identify a second user interface element from the plurality of user interface elements and a second location of the second user interface element, in accordance with a determination that one or more focus adjustment criteria have been satisfied, identify the second user interface element at the second location as the focus element, wherein the determination that the one or more focus adjustment criteria have been satisfied includes determining that a distance between the second location and the first location is within a focus adjustment threshold, and in accordance with a determination that the one or more focus adjustment criteria have not been satisfied, identify a third user interface element from the plurality of user interface elements and a third location of the third user interface element as the focus element.

Some examples of the disclosure are directed to an electronic device, comprising one or more processors, memory, means for presenting, via a display, a plurality of user interface elements in a computer-generated environment, means for, while presenting the plurality of user interface elements, identifying a first user interface element from the plurality of user interface elements and a first location of the first user interface element as a focus element, wherein the identification of the first user interface element from the plurality of user interface elements and the first location is performed in accordance with determining a first gaze location from eye gaze data, means for, while presenting the plurality of user interface elements including the identified focus element, detecting movement of a representation of an object in the computer-generated environment, means for, in accordance with the detected movement of the representation of the object and the first location, identifying a second user interface element from the plurality of user interface elements and a second location of the second user interface element, means for, in accordance with a determination that one or more focus adjustment criteria have been satisfied, identifying the second user interface element at the second location as the focus element, wherein the determination that the one or more focus adjustment criteria have been satisfied includes determining that a distance between the second location and the first location is within a focus adjustment threshold, and means for, in accordance with a determination that the one or more focus adjustment criteria have not been satisfied, identifying a third user interface element from the plurality of user interface elements and a third location of the third user interface element as the focus element.

Some examples of the disclosure are directed to an information processing apparatus for use in an electronic device, the information processing apparatus comprising means for presenting, via a display, a plurality of user interface elements in a computer-generated environment, means for, while presenting the plurality of user interface elements, identifying a first user interface element from the plurality of user interface elements and a first location of the first user interface element as a focus element, wherein the identification of the first user interface element from the plurality of user interface elements and the first location is performed in accordance with determining a first gaze location from eye gaze data, means for, while presenting the plurality of user interface elements including the identified focus element, detecting movement of a representation of an object in the computer-generated environment, means for, in accordance with the detected movement of the representation of the object and the first location, identifying a second user interface element from the plurality of user interface elements and a second location of the second user interface element, means for, in accordance with a determination that one or more focus adjustment criteria have been satisfied, identifying the second user interface element at the second location as the focus element, wherein the determination that the one or more focus adjustment criteria have been satisfied includes determining that a distance between the second location and the first location is within a focus adjustment threshold, and means for, in accordance with a determination that the one or more focus adjustment criteria have not been satisfied, identifying a third user interface element from the plurality of user interface elements and a third location of the third user interface element as the focus element.

Some examples of the disclosure are directed to an electronic device, comprising one or more processors, memory, and one or more programs, wherein the one or more programs are stored in the memory and configured to be executed by the one or more processors, the one or more programs including instructions for performing any of the methods disclosed above.

Some examples of the disclosure are directed to a non-transitory computer readable storage medium storing one or more programs, the one or more programs comprising instructions, which when executed by one or more processors of an electronic device, cause the electronic device to perform any of the methods disclosed above.

Some examples of the disclosure are directed to an electronic device, comprising one or more processors, memory, and means for performing any of the methods disclosed above.

Some examples of the disclosure are directed to an information processing apparatus for use in an electronic device, the information processing apparatus comprising means for performing any of the methods disclosed above.

The foregoing description, for purposes of explanation, has been described with reference to specific embodiments. However, the illustrative discussions above are not intended to be exhaustive or to limit embodiments of the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display:
presenting, via the display, one or more user interface elements in a computer-generated environment;
while presenting the one or more user interface elements, determining that one or more first selection criteria have been satisfied, including detection of a first gesture in the computer-generated environment;
in accordance with the determination that the one or more first selection criteria have been satisfied, determining that a user interface element has been selected;
in accordance with the determination that the user interface element has been selected and a determination that the first gesture is being maintained, detecting a movement gesture in the computer-generated environment; and
in accordance with a determination that the movement gesture satisfies one or more movement criteria, adjusting a value associated with the selected user interface element.

2. The method of claim 1, wherein in accordance with the determination that the user interface element has been selected and the determination that the first gesture is being maintained, presenting a first affordance associated with the selected user interface element in the computer-generated environment, the first affordance representative of the value being adjusted.

3. The method of claim 2, wherein in accordance with the adjusting of the value associated with the selected user interface element, an appearance of the first affordance is modified.

4. The method of claim 2, wherein the movement gesture is detected in the computer-generated environment at a location different from the first affordance.

5. The method of claim 1, wherein the detection of the first gesture is performed in accordance with detecting a pinch and hold gesture performed by a hand in the computer-generated environment.

6. The method of claim 1, further comprising determining a gaze location;
wherein the determination that the one or more first selection criteria have been satisfied includes determining a user interface element associated with the determined gaze location.

7. The method of claim 1, wherein in accordance with the determination that the user interface element has been selected, causing other user interface elements to cease being presented in the computer-generated environment.

8. The method of claim 1, further comprising:
presenting, via the display, the one or more user interface elements anchored to a first hand of a user in the computer-generated environment; and
wherein detecting the movement gesture is performed in accordance with detecting movements of the first hand of the user in the computer-generated environment.

9. An electronic device, comprising:
one or more processors;
memory; and
one or more programs, wherein the one or more programs are stored in the memory and configured to be executed by the one or more processors, the one or more programs including instructions for:
presenting, via a display, one or more user interface elements in a computer-generated environment;
while presenting the one or more user interface elements, determining that one or more first selection criteria have been satisfied, including detection of a first gesture in the computer-generated environment;
in accordance with the determination that the one or more first selection criteria have been satisfied, determining that a user interface element has been selected;
in accordance with the determination that the user interface element has been selected and a determination that the first gesture is being maintained, detecting a movement gesture in the computer-generated environment; and
in accordance with a determination that the movement gesture satisfies one or more movement criteria, adjusting a value associated with the selected user interface element.

10. The electronic device of claim 9, wherein in accordance with the determination that the user interface element has been selected and the determination that the first gesture is being maintained, presenting a first affordance associated with the selected user interface element in the computer-generated environment, the first affordance representative of the value being adjusted.

11. The electronic device of claim 10, wherein in accordance with the adjusting of the value associated with the selected user interface element, an appearance of the first affordance is modified.

12. The electronic device of claim 10, wherein the movement gesture is detected in the computer-generated environment at a location different from the first affordance.

13. The electronic device of claim 9, wherein the detection of the first gesture is performed in accordance with detecting a pinch and hold gesture performed by a hand in the computer-generated environment.

14. The electronic device of claim 9, the one or more programs further including instructions for:
determining a gaze location;
wherein the determination that the one or more first selection criteria have been satisfied includes determining a user interface element associated with the determined gaze location.

15. The electronic device of claim 9, wherein in accordance with the determination that the user interface element has been selected, causing other user interface elements to cease being presented in the computer-generated environment.

16. The electronic device of claim 9, the one or more programs further including instructions for:
presenting, via the display, the one or more user interface elements anchored to a first hand of a user in the computer-generated environment; and
wherein detecting the movement gesture is performed in accordance with detecting movements of the first hand of the user in the computer-generated environment.

17. A non-transitory computer readable storage medium storing one or more programs, the one or more programs comprising instructions, which when executed by one or more processors of an electronic device, cause the electronic device to:
present, via a display, one or more user interface elements in a computer-generated environment;
while presenting the one or more user interface elements, determine that one or more first selection criteria have been satisfied, including detection of a first gesture in the computer-generated environment;
in accordance with the determination that the one or more first selection criteria have been satisfied, determine that a user interface element has been selected;
in accordance with the determination that the user interface element has been selected and a determination that the first gesture is being maintained, detect a movement gesture in the computer-generated environment; and
in accordance with a determination that the movement gesture satisfies one or more movement criteria, adjust a value associated with the selected user interface element.

18. The non-transitory computer readable storage medium of claim 17, wherein in accordance with the determination that the user interface element has been selected and the determination that the first gesture is being maintained, presenting a first affordance associated with the selected user interface element in the computer-generated environment, the first affordance representative of the value being adjusted.

19. The non-transitory computer readable storage medium of claim 18, wherein in accordance with the adjusting of the value associated with the selected user interface element, an appearance of the first affordance is modified.

20. The non-transitory computer readable storage medium of claim 18, wherein the movement gesture is detected in the computer-generated environment at a location different from the first affordance.

21. The non-transitory computer readable storage medium of claim 17, wherein the detection of the first gesture is performed in accordance with detecting a pinch and hold gesture performed by a hand in the computer-generated environment.

22. The non-transitory computer readable storage medium of claim 17, the instructions, when executed by one or more processors, further cause the electronic device to:
determine a gaze location;
wherein the determination that the one or more first selection criteria have been satisfied includes determining a user interface element associated with the determined gaze location.

23. The non-transitory computer readable storage medium of claim 17, wherein in accordance with the determination that the user interface element has been selected, causing other user interface elements to cease being presented in the computer-generated environment.

24. The non-transitory computer readable storage medium of claim 17, the instructions, when executed by one or more processors, further cause the electronic device to:
presenting, via the display, the one or more user interface elements anchored to a first hand of a user in the computer-generated environment; and
wherein detecting the movement gesture is performed in accordance with detecting movements of the first hand of the user in the computer-generated environment.
